(19) United States
(12) Patent Application Publication
(10) Pub. No.: US 2007/0212656 A1
(43) Pub. Date: Sep. 13, 2007

(54) PHOTOTHERMOGRAPHIC MATERIAL

(75) Inventor: Kiyoshi FUKUSAKA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/682,146

(22) Filed: Mar. 5, 2007

(30) Foreign Application Priority Data
Mar. 13, 2006 (JP) JP2006-067245

(51) Int. Cl. G03C 1/00

(52) U.S. Cl. 430/619

(57) ABSTRACT

A photothermographic material is disclosed, comprising on at least one side of a support a light-sensitive silver halide, wherein the photothermographic material further comprises a compound represented by formula (1) and a compound represented by formula (2).

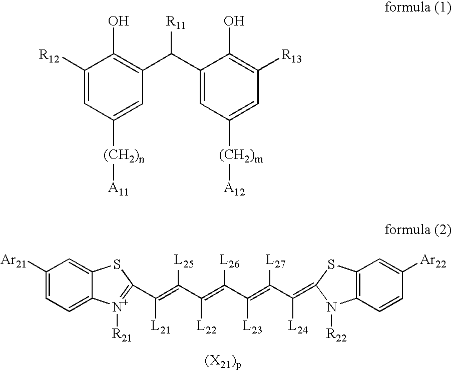

This application claims priority from Japanese Patent Application No. JP2006-067245 filed on Mar. 13, 2006, which is incorporated hereinto by reference.

### FIELD OF THE INVENTION

The present invention relates to a thermally developable photothermographic material.

### BACKGROUND OF THE INVENTION

In the field of medical treatment and graphic arts, there have been concerns in processing of imaging materials with respect to effluent produced from wet-processing, and recently, reduction of the processing effluent is strongly demanded in terms of environmental protection and space saving. There has been desired a photothermographic dry imaging material for photographic use, capable of forming distinct black images exhibiting high sharpness, enabling efficient exposure by means of a laser imager or a laser image setter.

Known as such a technique are silver salt photothermographic dry imaging materials comprising an organic silver salt, light-sensitive silver halide and a reducing agent on a support, as described in U.S. Pat. Nos. 3,152,904 and 3,487,075 by D. Morgan and B. Shely, and D. H. Klosterboer, “Dry Silver Photographic Material” (Handboook of Imaging Materials, Marcel Dekker Inc. page 48, 1991). Such a silver salt photothermographic dry imaging material (hereinafter also denoted simply as photothermographic material), which does not employ any solution type processing chemical, can provide users a simple and environment-friendly system.

In one aspect, this photothermographic material contains light-sensitive silver halide as a photosensor and a light-insensitive aliphatic carboxylic acid silver salt (hereinafter, also denoted as an organic silver salt) as a silver ion source, and is thermally developed usually at 80° C. or higher by an included reducing agent for silver ions (hereinafter also denoted simply as a reducing agent) to form an image, without performing fixation.

However, photothermographic materials, in which an organic silver salt and light-sensitive silver halide are contained together with a reducing agent, readily causes fogging after raw stock. After being exposed, the photothermographic material is thermally developed and remains unfixed. After being subjected to thermal development, all or a part of the silver halide, organic silver salt and reducing agent remain, so that metallic silver is thermally or photolytically formed after storage over a long period, resulting in problems such as change in image quality, for instance, silver image color. Accordingly, there have been explored a technique for inhibiting deteriorated performance described above.

In order to obtain images exhibiting a high density, various bis phenol reducing agents were disclosed, for example, as described in JP-A Nos. 2001-188314, 2004-4650 and 2004-4767 (hereinafter, the term JP-A refers to Japanese Patent Application Publication). However, when a photothermographic material was aged over a long period of time prior to thermal development or when a silver image obtained by developing a photothermographic material was stored over a long period of time, there were problems that fogging was easily caused. Further, formed silver images became yellowish, leading to lowering of diagnostic capability for medical use, so that further improvement is desired.

### SUMMARY OF THE INVENTION

Accordingly, it is an object of the present invention to provide a thermally developable photothermographic material exhibiting low fogging, improved raw stock stability, superior storage stability of silver images and superior silver image tone.

Thus, one aspect of the invention is directed to a photothermographic material comprising on at least one side of a support a light-sensitive silver halide, wherein the photothermographic material further comprises a compound represented by formula (1) and a compound represented by formula (2):

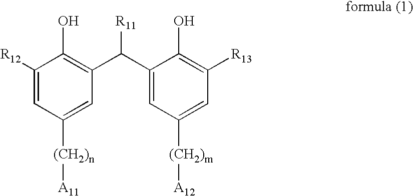

wherein R₁₁ is a hydrogen atom or a substituent; R₁₂ and R₁₃ are each a branched alkyl group or a cycloalkyl group; A₁₁ and A₁₂ are each a hydroxyl group or a group capable of forming a hydroxyl group upon deprotection; n and m are each an integer of 3 to 5,

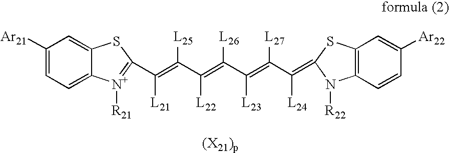

wherein L₂₁ through L₂₇ are each a hydrogen atom, a halogen atom, an amino group, an alkylthio group, an arylthio group, a lower alkyl group, a lower alkoxy group, an aryloxy group, an aryl group, a heterocyclic group or a nonmetallic atom group necessary to form a 5-, 6- or 7-membered ring by linking L₂₁ to L₂₂, L₂₂ to L₂₃, L₂₃ to L₂₄, L₂₅ to L₂₆ or L₂₆ to L₂₇; R₂₁ and R₂₂ are each an aliphatic group, provided that R₂₁ and L₂₁ or R₂₂ and L₂₄ may combine with each other to form a 5-, 6- or 7-membered ring structure; Ar₂₁ and Ar₂₂ are each an aryl group or a heterocyclic group; X₂₁ is an ion necessary to compensate for an intramolecular charge and p is the number of ions necessary to compensate for an intramolecular charge.

### DETAILED DESCRIPTION OF THE INVENTION

First, there will be detailed the compound represented by formula (1).

In the foregoing formula (1), R₁₁ is a hydrogen atom or a substituent. Examples of a substituent include an alkyl group, a cycloalkyl group, an alkenyl group, an alkynyl group, an aryl group, a heterocyclic group, a halogen atom and a cyano group. Of these, a hydrogen atom, an alkyl group, a cycloalkyl group or an alkenyl group is preferred, a hydrogen atom or an alkyl group is more preferred and a hydrogen atom is still more preferred. These substituents may further be substituted. Examples of such a substituent include an alkyl group, a cycloalkyl group, a halogenated alkyl group, an alkenyl group, alkynyl group, an aryl group, a heterocyclic group, a halogen atom, cyano group, hydroxy group, carboxy group, an alkoxy group, an aryloxy group, silyloxy group, heterocyclic-oxy group, an acyloxy group, a carbamoyloxy group, an alkoxycarbonyloxy group, an aryloxycarbonyloxy group, an amino group, an anilino group, an acylamino group, an aminocarbonylamino group, an alkoxycarbonylamino group, an aryloxycarbonylamino group, a sulfamoylamino group, an alkyl- or aryl-sulfonylamino group, mercapto group, an alkylthio group, an arylthio group, a heterocyclic-thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl-or heterocyclic-azo group, an imido group, a silyl group, a hydrazine group, a ureido group, a boronic acid group, a phosphate group, sulfato group and other substituent groups.

R₁₂ and R₁₃ are each a branched alkyl group or a cycloalkyl group. Examples of such a branched alkyl group include tert-butyl, tert-amyl, isopropyl, isobutyl, 1,1-dimethylbutyl, 1-methylbutyl, 1,3-dimethylbutyl, 1-methylpropyl, 1,1,2-trimethylpropyl, and 1-ethyl-1-methylpropyl. Examples of a cycloalkyl group include cyclohexyl, cyclopentyl, cyclobutyl, cyclopentyl, 1-methylcyclohexyl, 1-methylcyclopentyl, 1-methylcyclobutyl and 1-methylcyclopropyl. R₁₂ and R₁₃ are each preferablyl-methylcyclohexyl, tert-butyl, 1,1-dimethylbutyl or tert-amyl, and more preferably t-butyl.

These branched alkyl group and cycloalkyl group may be substituted and examples of a substituent include a hydroxyl group, a cyano group, a mercapto group, a halogen atom, an amino group, an imido group, a silyl group and a hydrazine group.

A₁₁ and A₁₂ are each a hydroxy group or a group capable of forming a hydroxy group upon deprotection, and preferably a hydroxy group. The group capable of forming a hydroxy group upon deprotection is a group which is cleaved (or deprotected) under the action of an acid and/or heat to form a hydroxy group. Specific examples thereof include an ether group (e.g., methoxy, tert-butoxy, allyoxy, benzoyloxy, triphenylmethoxy, trimethylsilyloxy), a hemiacetal group (e.g., tetrahydropyranyloxy), an ester group (e.g., acetyloxy, benzoyloxy, p-nitrobenzoyloxy, formyloxy, trifluoroacetyloxy, pivaloyloxy), a carbonate group (e.g., ethoxycarbonyloxy, phenoxycarbonyloxy, tert-butyloxycarbonyloxy), a sulfonate group (e.g., p-toluenesulfonyloxy, benzenesulfonyloxy), a carbamoyloxy group (e.g., phenylcarbamoyloxy), a thiocarbonyloxy group (e.g., benzylthiocarbonyloxy), a nitric acid ester group, and a sulphenato group (e.g., 2,4-dinitrobenzenesulphenyloxy).

In formula (1), n and m are each an integer of 3 to 5, preferably 3 or 4, and more preferably 3.

Specific examples of the compound of formula (1), which is hereinafter also called a reducing agent of the invention, are shown below but are not limited to these.

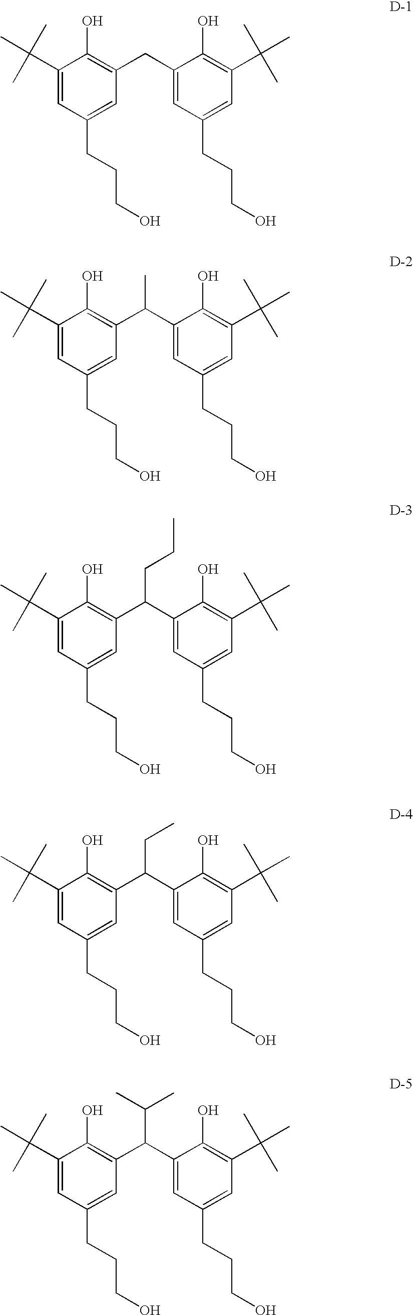

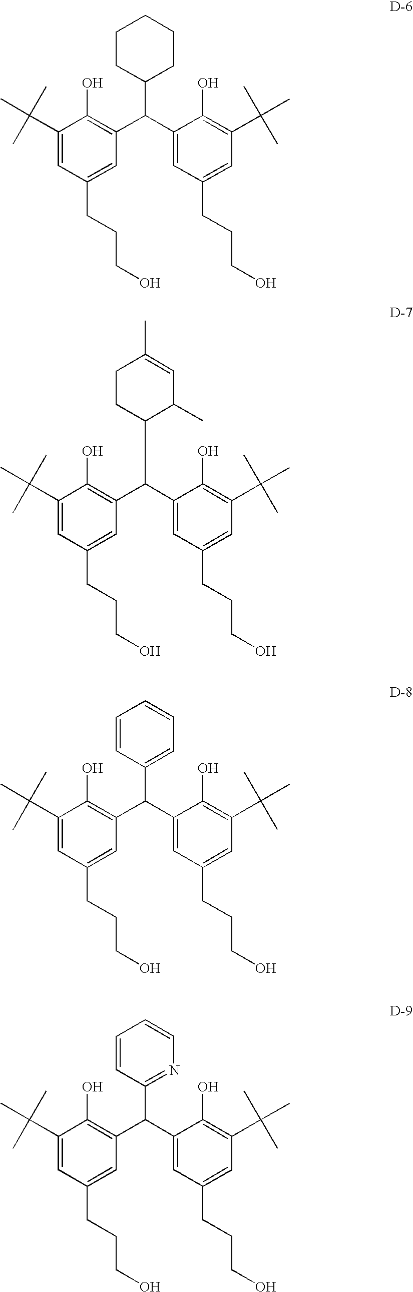

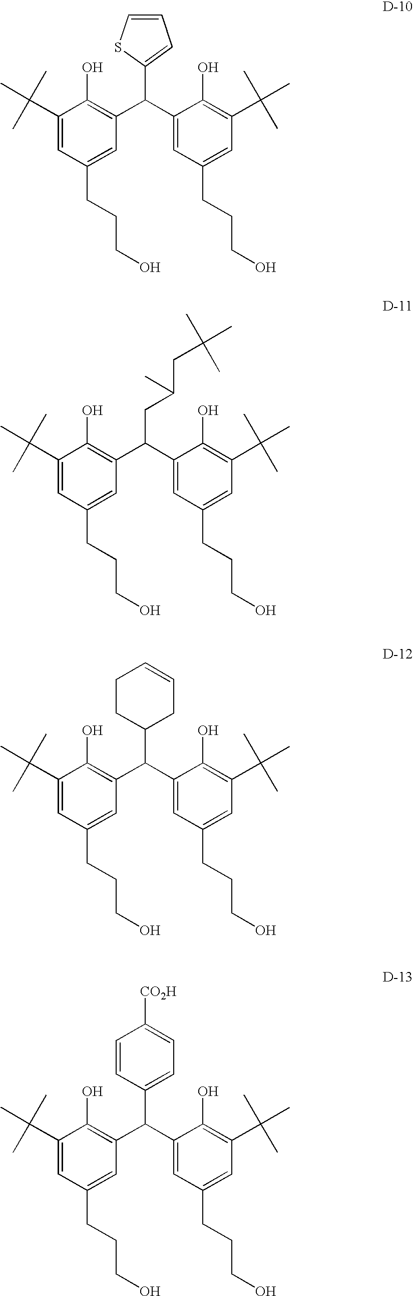

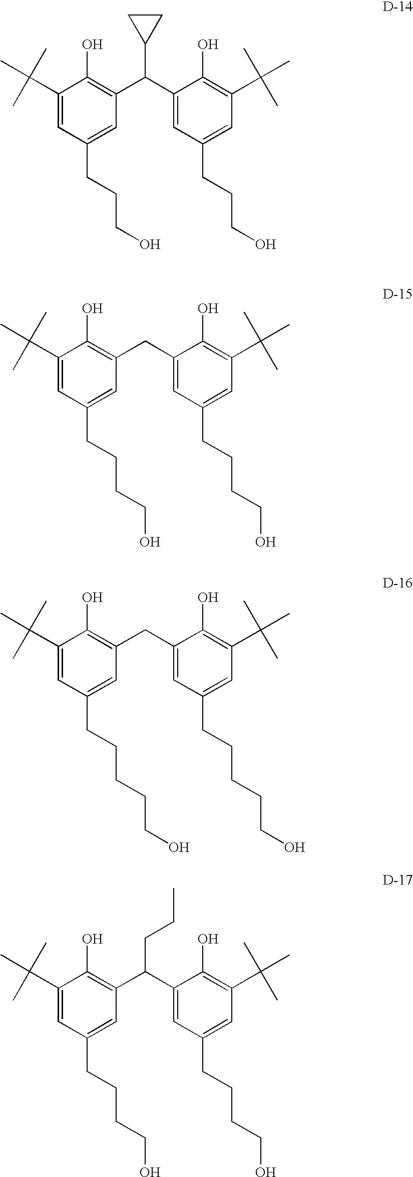

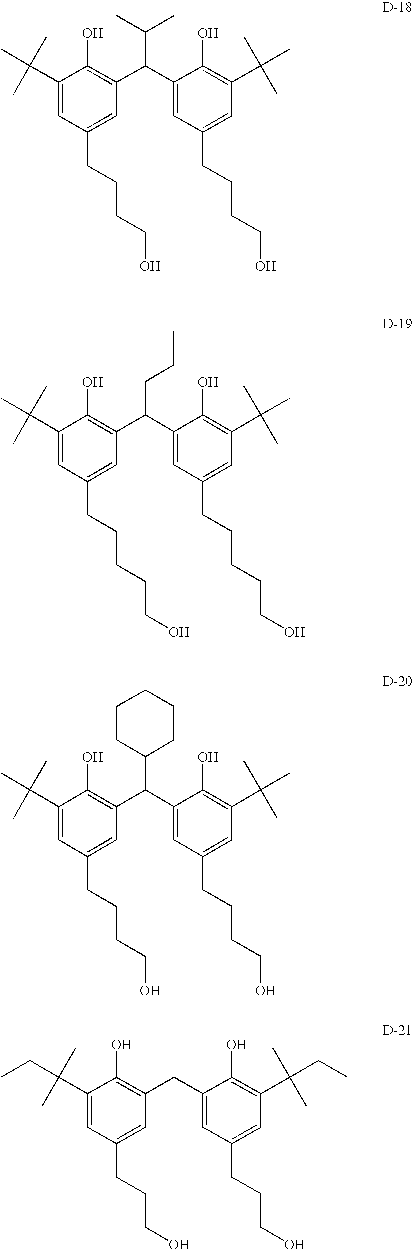

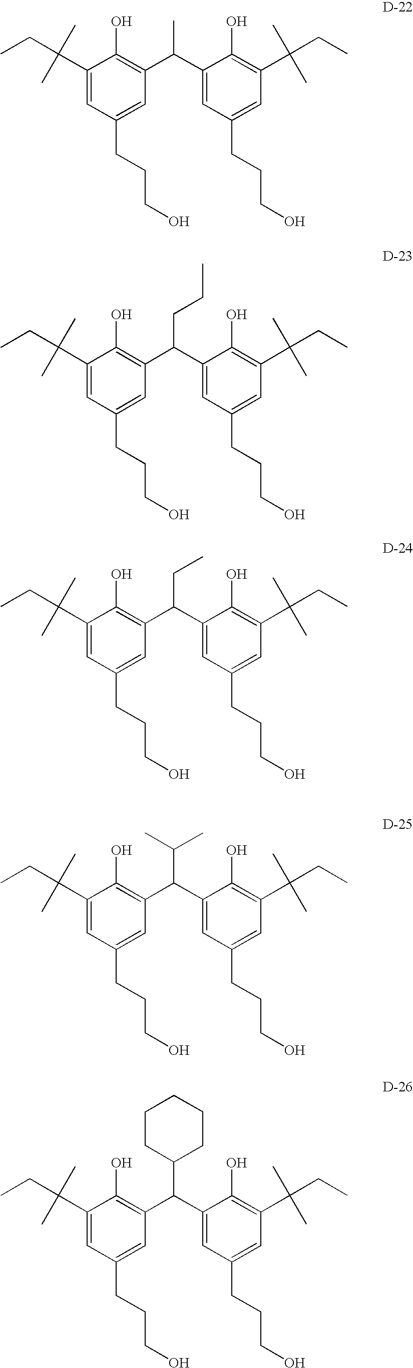

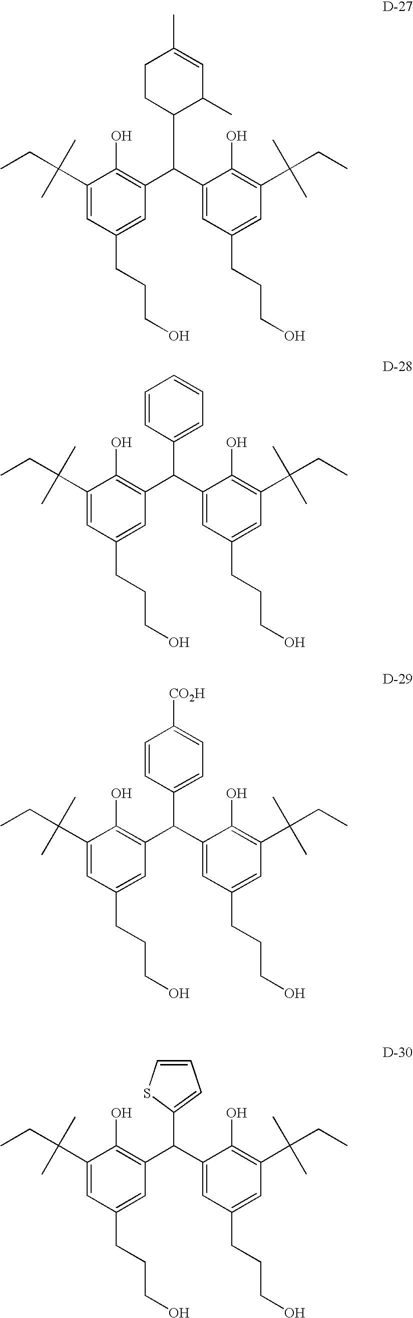

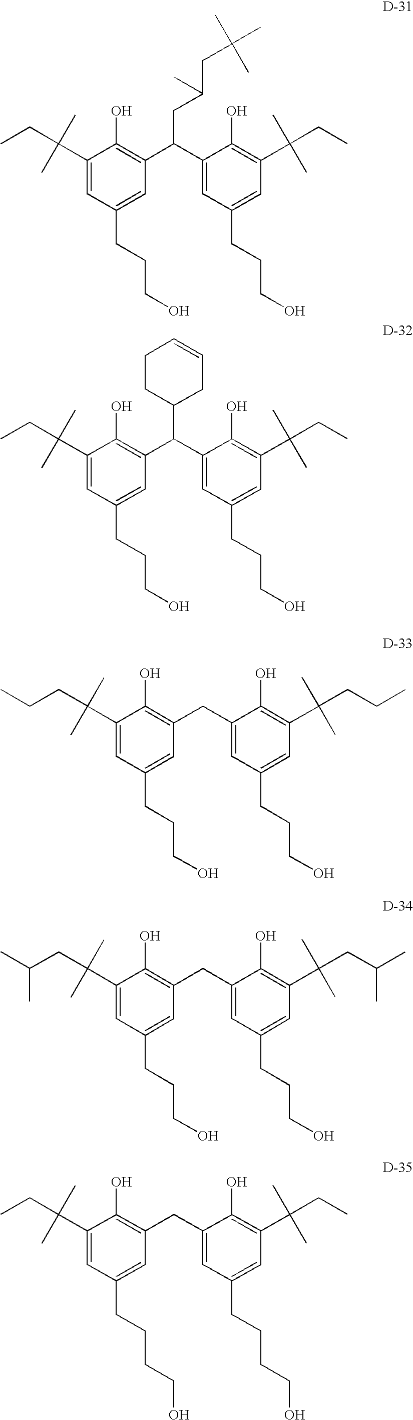

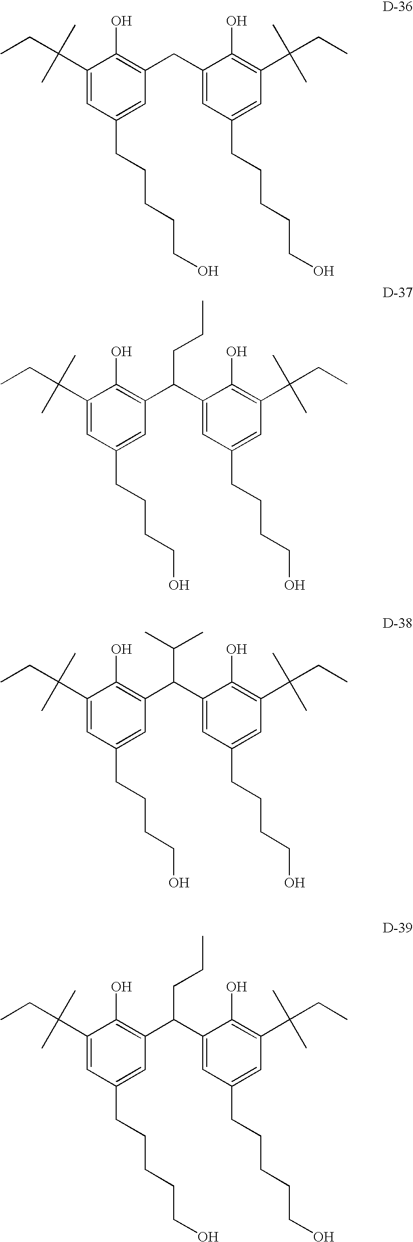

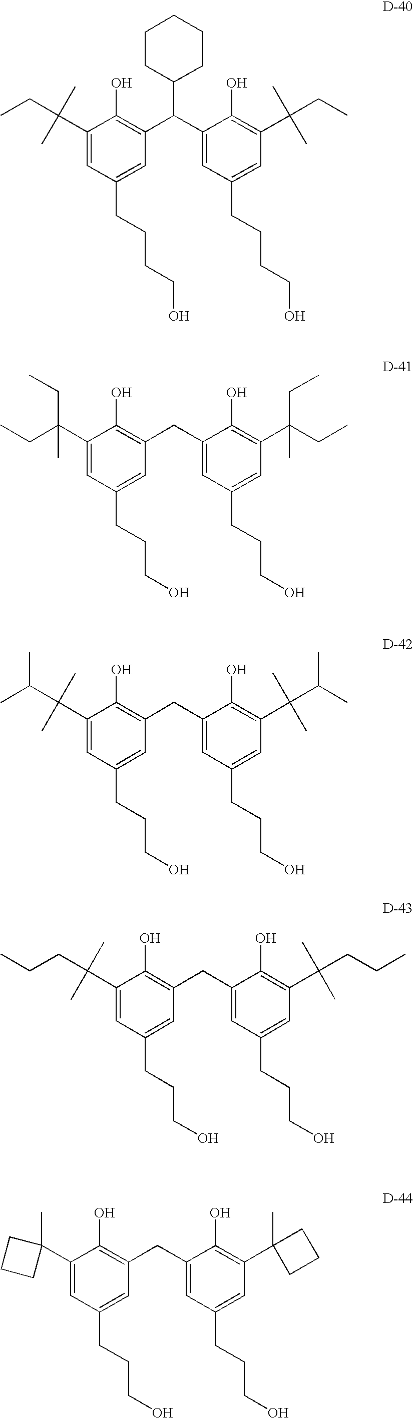

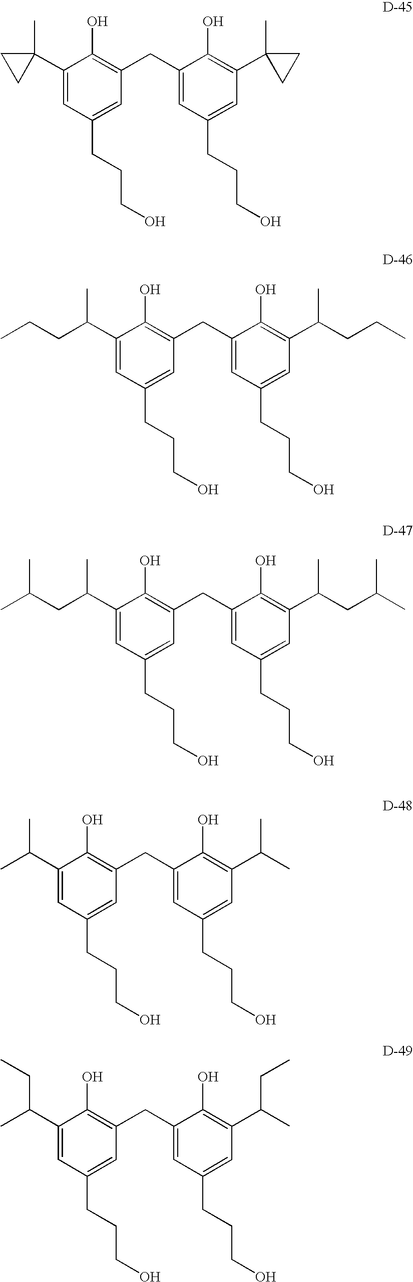

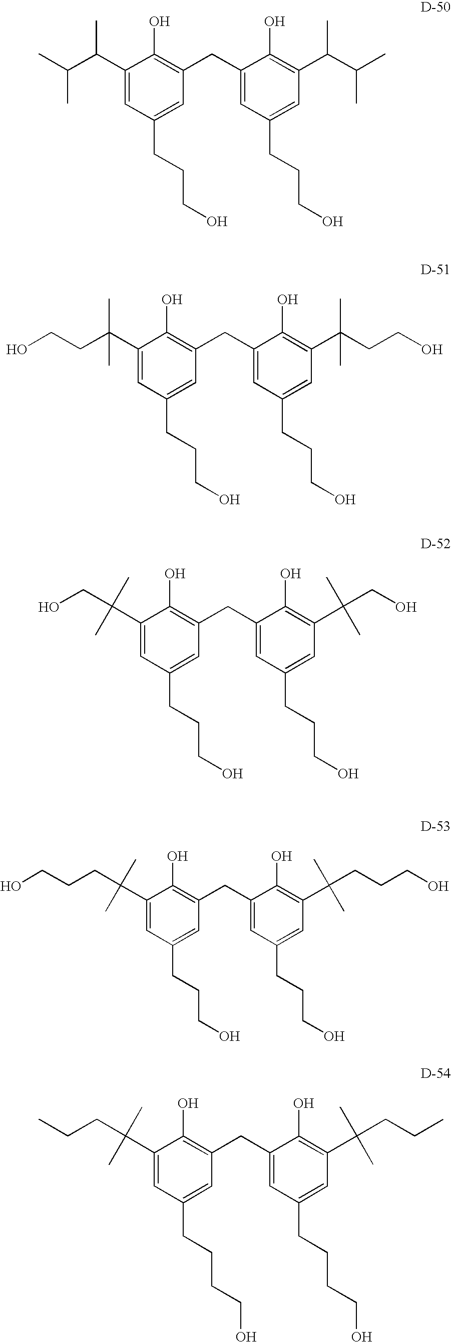

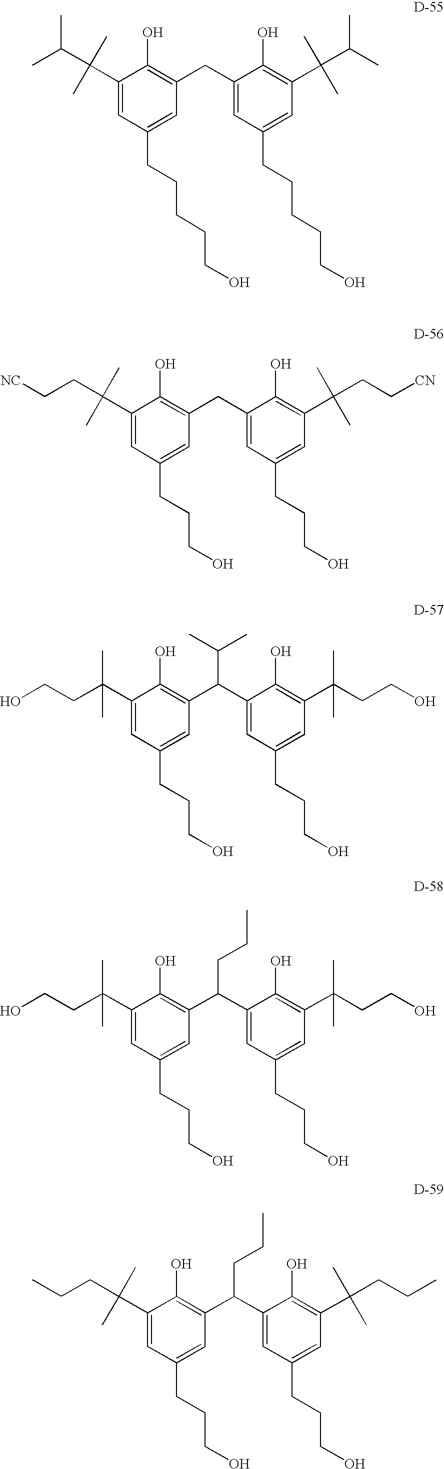

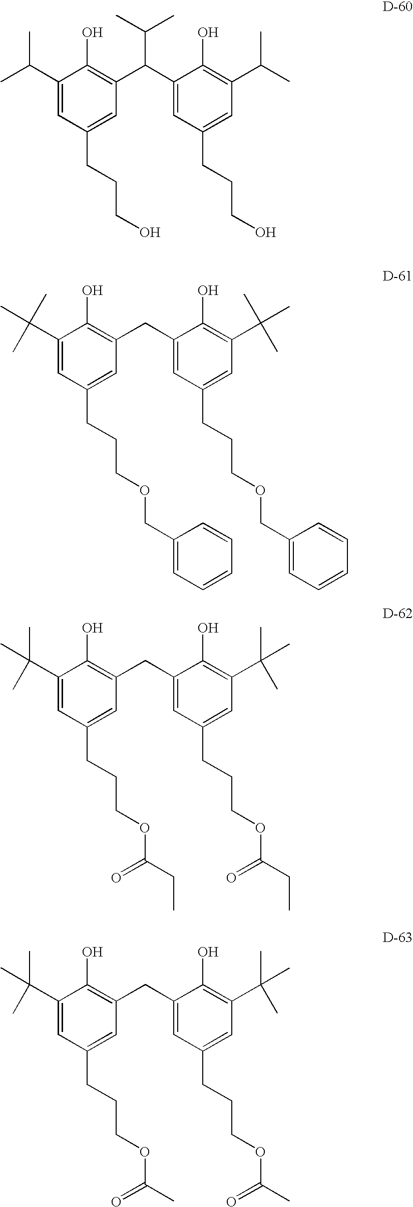

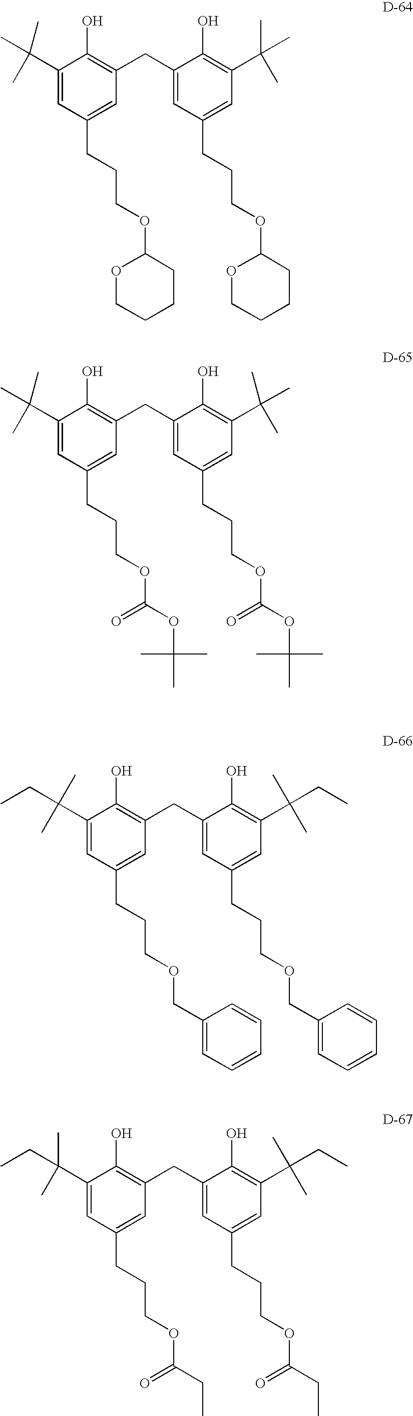

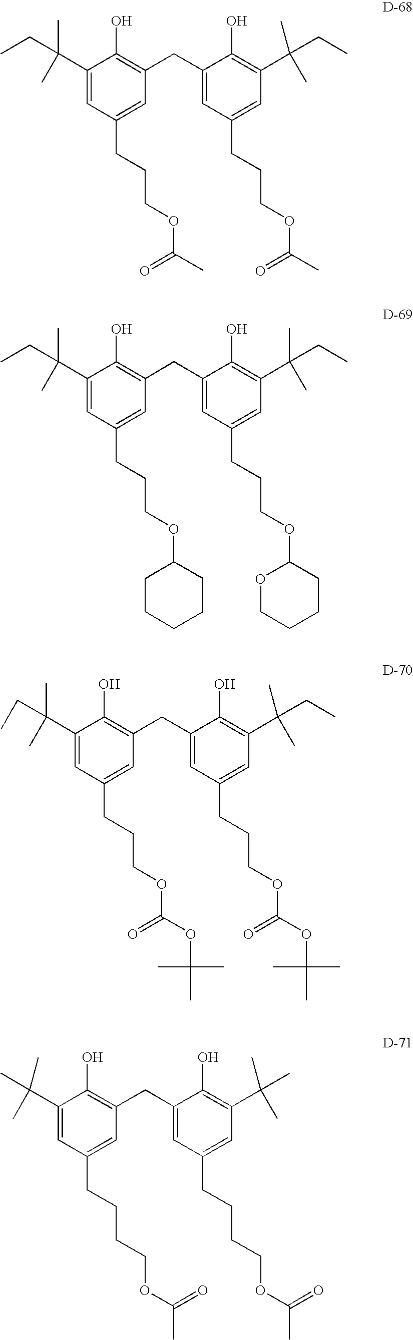

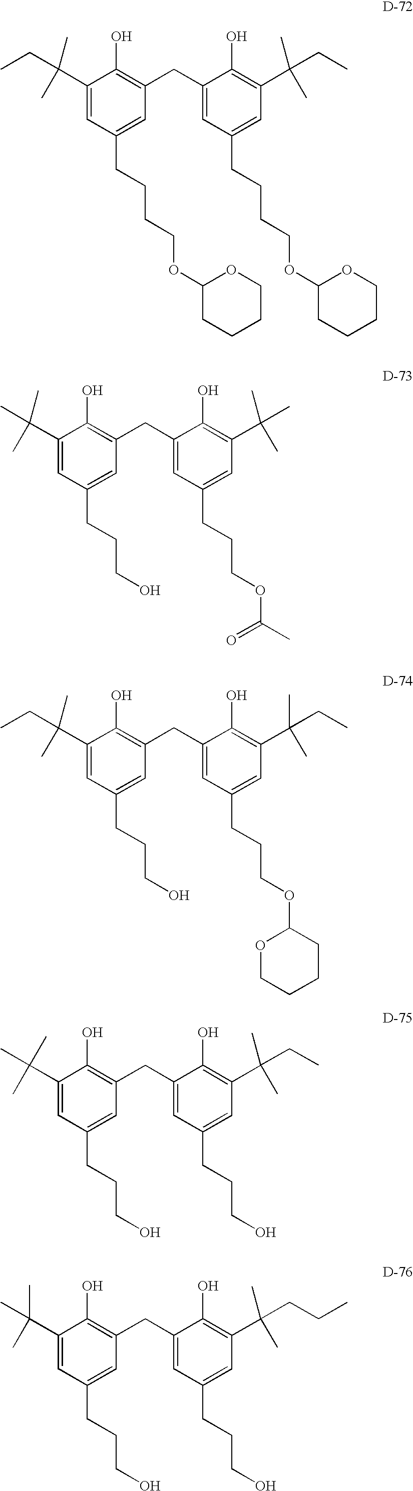

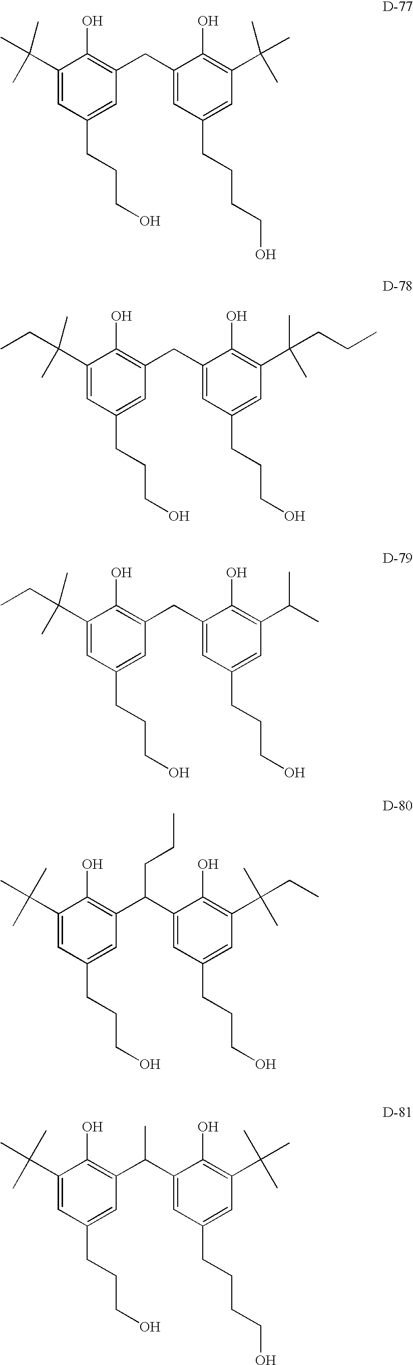

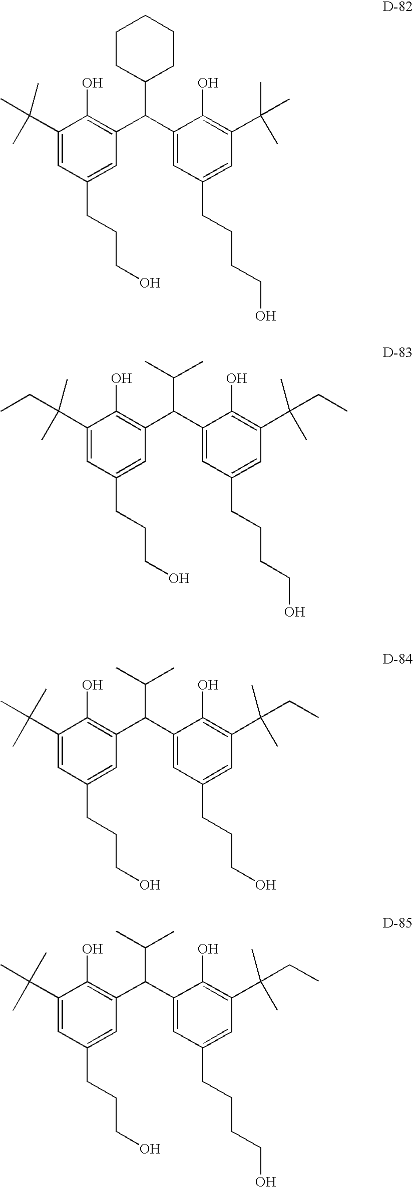

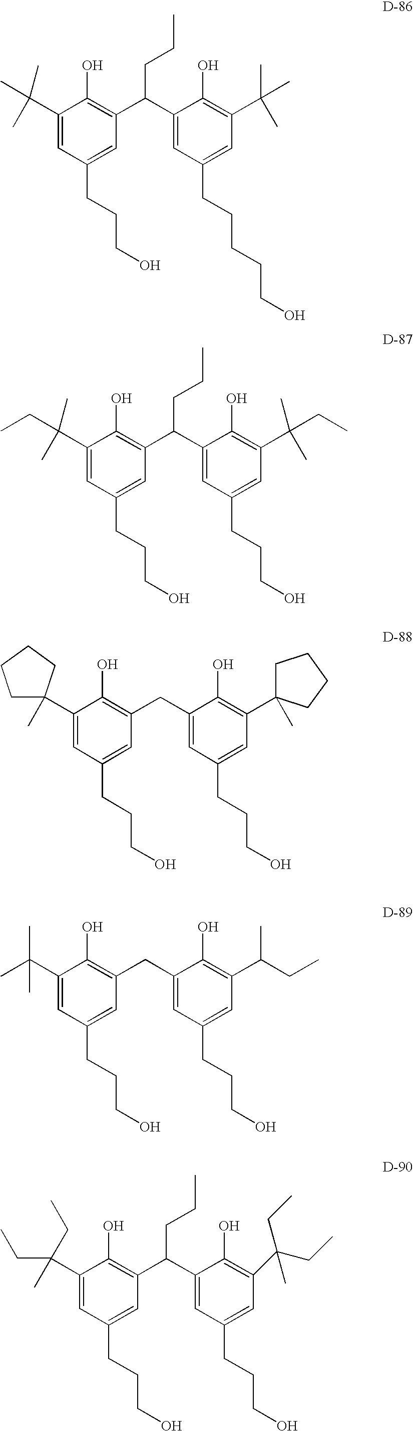

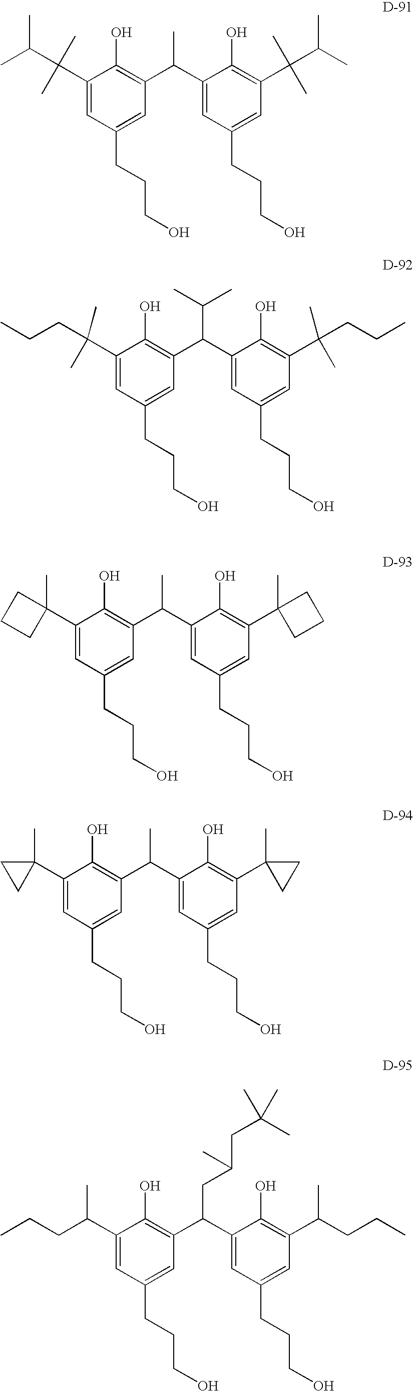

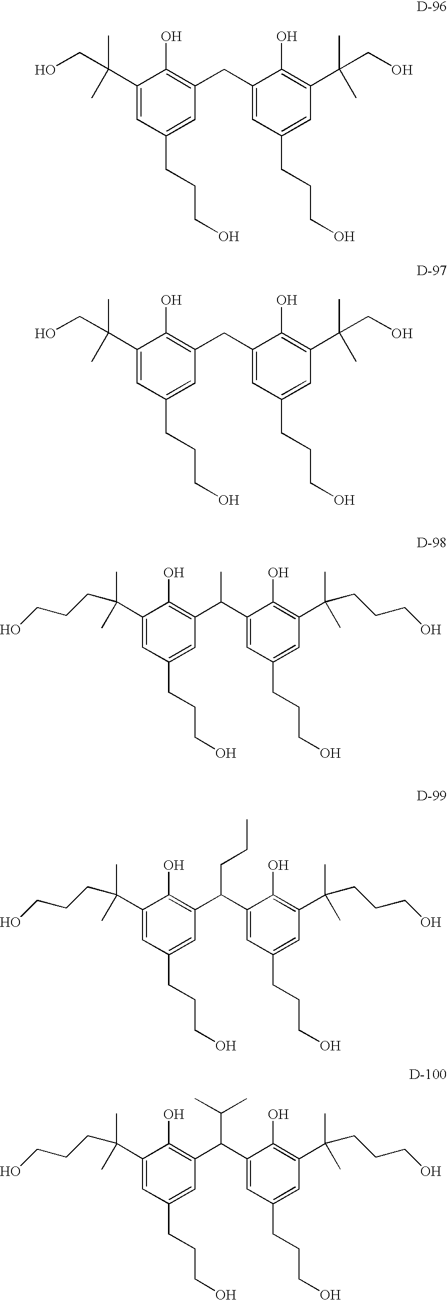

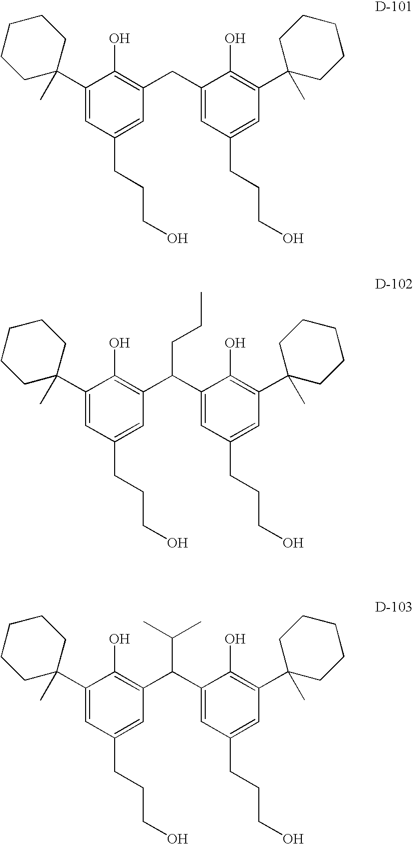

The compound of formula (1) as a reducing agent may be used alone or in combination thereof, or may be used in combination with other reducing agents. Reducing agents usable in combination with the compound of formula (1) are those described in JP-A No. 11-65021, paragraph No. 0043-0045; European Patent Application Publication No. 830,764A1, page 7, line 34 to page 18, line 12; JP-A No. 2003-302723, paragraph No. 0124-0133; JP-A No. 2003-315954, paragraph No. 0124-127; and JP-A No. 2004-4650, paragraph No. 0042-0057. In the photothermographic material of the invention, specifically bisphenol reducing agents, e.g., 6,6′-(cyclohexylmethylene)bis(2,4-dimethylphenol), are preferably used in combination with the compounds of formula (1).

The compound of formula (1) may be incorporated into a light-sensitive layer containing an organic silver salt or an adjacent light-insensitive layer.

The foregoing reducing agents may be incorporated into the photothermographic material in any appropriate form, such as an emulsified dispersion or a solid particle dispersion.

Further, polyphenol compounds described in U.S. Pat. Nos. 3,589,903 and 4,021,249, British Patent No. 1,486,148, JP-A Nos. 51-51933, 50-36110, 50-116023 and 52-84727, and JP-B No. 51-35727 (hereinafter, the term JP-B refers to Japanese Patent Publication); bisnaphthols such as 2,2′-dihydroxy-1,1′-binaphthyl, described in U.S. Pat. No. 3,672,904; and sulfonamidophenol or sulfonamidonaphthol, such as 4-benzenesulfonamidophenol, 2-benzenesulfonamidophenol, 2,6-dichloro-4-benzenesulfonamidophenol and 4-benzenesulfonamidonapthol are also usable as a reducing agent.

The content of a reducing agent, depending on the kind of an organic silver salt or the reducing agent, or other additives, is generally from 0.05 to 10 mol per mol of organic silver salt, and preferably from 0.1 to 3 mol. In the invention, it is often preferred that the reducing agent is added to a light-sensitive emulsion containing light-sensitive silver halide and organic silver salt grains, immediately before coating and then coated, whereby variation in photographic performance while standing is minimized.

Next, the compound of formula (2) will be described.

In the formula (2), L₂₁ through L₂₇ are each a hydrogen atom, a halogen atom, an amino group, an alkylthio group, an arylthio group, a lower alkyl group, a lower alkoxy group, an aryloxy group, an aryl group or a heterocyclic group. Examples of a halogen atom include fluorine, chlorine, bromine and iodine; an amino groups include substituted and unsubstituted amino groups, such as amino, dimethylamino, diphenylamino, and methyl-phenylamino; examples of an alkylthio group include methylthio, ethylthio and benzylthio; examples of an arylthio group include substituted and unsubstituted arylthio groups such as phenylthio and m-fluorophenylthio; a lower alkyl group is a straight chain or branched alkyl group having carbon atoms of 5 or less and specific examples thereof include methyl, ethyl, propyl, butyl, pentyl and iso-propyl.

A lower alkoxy group is one having carbon atoms of 4 or less and specific examples thereof include methoxy, ethoxy, propoxy, iso-propoxy; an aryloxy group is a substituted or unsubstituted one and specific examples thereof include phenoxy, p-tolyloxy and m-carboxyphenyloxy; an aryl group is a substituted or unsubstituted one and specific examples thereof include phenyl, 2-naphthyl, 1-naphthyl, o-tolyl, o-methoxyphenyl, mochlorophenyl, m-bromophenyl, p-tolyl and p-ethoxyphenyl; a heterocyclic group is a substituted or unsubstituted one and specific examples thereof include 2-furyl, 5-methyl-2-furyl, 2-thienyl, 2-imidazolyl, 2-methyl-1-imidazolyl, 4-phenyl-2-thiazolyl, 5-hydroxy-2-benzothiazolyl, 2-pyridyl, and 1-pyrrolyl. These groups may be substituted by a substituent such as a phenyl group, a halogen atom, an alkoxy group or a hydroxyl group. L₂₁ through L₂₇ are preferably a hydrogen atom, a lower alkyl group, a halogen atom or an aryl group, and more preferably a lower alkyl group or an aryl group.

Further, L₂₁ through L₂₇ are a nonmetallic atom group necessary to form a 5- to 7-membered ring by linking L₂₁ to L₂₂, L₂₂ to L₂₃, L₂₃ to L₂₄, L₂₅ to L₂₆ or L₂₆ to L₂₇. Examples of the formed 5- to 7-membered ring include cyclopentane, cyclohexane, cycloheptene and decalin rings. These rings may be substituted by, for example, a lower alkyl group, a lower alkoxy group or an aryl group, as defined in L₂₁ through L₂₇. L₂₁ through L₂₇ are each preferably a cyclopentane or decalin ring.

R₂₁ and R₂₂ are each an aliphatic group and examples of an aliphatic group include a straight chain or branched alkyl group having 1 to 30 carbon atoms (e.g., methyl, ethyl, propyl, butyl, pentyl, iso-pentyl, 2-ethyl-hexyl, octyl, decyl), an alkenyl group having 3 to 30 carbon atoms (e.g., 2-propenyl, 3-butenyl, 1-methyl-3-propenyl, 3-pentenyl1-methyl-3-butenyl, 4-hexenyl) and an aralkyl group having 7 to 30 carbon atoms (e.g., benzyl, phenethyl). R₂₁ and R₂₂ are preferably a straight chain or branched alkyl group having 1 to 20 carbon atoms or an alkenyl group having 3 to 20 carbon atoms, more preferably a straight chain or branched alkyl group having 4 to 16 carbon atoms, and still more preferably a straight chain or branched alkyl group having 6 to 12 carbon atoms.

These aliphatic groups may be substituted and examples of a substituent include a halogen atom (e.g., fluorine, chlorine, bromine), a vinyl group, an aryl group (e.g., phenyl, p-tolyl, p-bromophenyl), trifluoromethyl, an alkoxy group (e.g., methoxy, ethoxy, methoxyethoxy), an aryloxy group (e.g., phenoxy, p-tolyloxy), a cyano group, a sulfonyl group (e.g., methanesulfonyl, trifluoromethanesulfonyl, p-toluenesulfonyl), an alkoxycarbonyl group (e.g., ethoxycarbonyl, butoxycarbonyl), an amino group (e.g., amino, biscarboxy-methylamino), a heterocyclic group (e.g., tetrahydrofurfuryl, 2-pyrrolidinone-1-yl), an acyl group (e.g., acetyl, benzoyl), an ureido group (e.g., ureido, 3-methylureido, 3-phenylureido), a thioureido group (e.g., thioureido, 3-methylthioureido), an alkylthio group (e.g., methylthio, ethylthio), an arylthio group (e.g., phenylthio), a heterocyclic-thio group (e.g., 2-thienylthio, 3-thienylthio, 4-imidazolylthio), a carbonyloxy group (e.g., acetyloxy, propanoyloxy, benzoyloxy), an acylamino group (e.g., acetylamino, benzoylamino), a thioamido group (e.g., thioacetoamido, thiobenzoylamino), a sulfo group, a carboxyl group, phosphono group, a sulfato group, a hydroxyl group, a mercapto group, a sulfino group, a carbamoyl group (e.g., carbamoyl, N-methylcarbamoyl, N,N-tetramethylenecarbamoyl9, a sulfamoyl group (e.g., sulfamoyl, N,N-3-oxapentamethyleneaminosulfonyl), a sulfonamido group (e.g., methanesulfonamido, butanesulfoneamido), a sulfonylaminocarbonyl group (e.g., methanesulfonylaminocarbonyl, ethanesulfonylaminocarbonyl), an acylaminosulfonyl group (e.g., acetoamidosulfonyl, methoxyacetoamidosulfonyl), an acylaminocarbonyl group (e.g., acetoamidocarbonyl, methoxyacetoamidocarbonyl), and a sulfinylaminocarbonyl group (e.g., methanesulfinylaminocarbonyl, ethanesulfinylaminocarbonyl). Of these substituent groups, a vinyl group, an aryl group, a heterocyclic group, a cyano group, a sulfonyl group, an acyl group, a ureido group, a thioureido group, an alkylthio group, a heterocyclic-thio group, a carbonyloxy group, an acylamino group, a thioamido group, a carboxy group, a hydroxyl group, a mercapto group, a carbamoyl group, a sulfamoyl group, a sulfonamido group or an acylaminocarbonyl group is preferred, and a vinyl group, an aryl group, a cyano group, an acyl group, an alkylthio group, a carbonyloxy group, an acylamino group or a hydroxyl group is more preferred.

Further, R₂, and L₂₁, or R₂₂ and L₂₄ may combine with each other to form a 5- to 7-membered ring structure.

Ar₂₁ and Ar₂₂ are each an aryl group or a heterocyclic group. An aryl group may be substituted or unsubstituted and specific examples thereof include phenyl, 2-naphthyl, 1-naphthyl, o-tolyl, o-methylphenyl, m-chlorophenyl, m-bromophenyl, p-tolyl, and p-ethoxyphenyl. A heterocyclic group may be substituted or unsubstituted and specific examples thereof include 2-furyl, 5-methyl-2-furyl, 2-thienyl, 2-imidazolyl, 2-methyl-1-imidazolyl, 4-phenyl-2-thiazolyl, 5-hydroxy-2-benzothiazolyl, 2-pyridyl and 1-pyrrolyl. These groups may be substituted by substituents as cited in R₂₁ and R₂₂. Ar₂₁ and Ar₂₂ are each preferably an aryl group and more preferably a phenyl group.

In the formula (2), in cases where substituted by a cationic or anionic charged group, a counter ion is formed with an equivalent anion or cation so as to compensate for a charge within the molecule. For example, in the case of an ion necessary to compensate for an intramolecular charge represented by X₂₁, specific examples of a cation include a proton, an organic ammonium ion (e.g., trimethylammonium, triethanolammonium, pyridinium) and inorganic cation (e.g., cations such as sodium and potassium); specific examples of an cid anion include a halogen ion (e.g., chloride, bromide and iodide ions), p-toluenesulfonic acid ion, a perchlorate ion, a tetrafluoroborate ion, a sulfate ion, a methylsulfate ion, ethylsulfate ion, a methanesulfonic acid ion, a trifluoromethanesulfonic acid ion, and hexafluorophosphoric acid ion. Further, p is the number of ions necessary to compensate for an intramolecular charge.

The photothermographic material of the invention preferably contains a compound represented by formula (3):

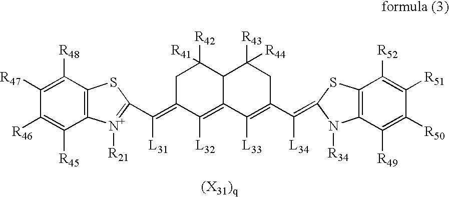

wherein L₃₁ through L₃₄ are each a hydrogen atom, a halogen atom, an amino group, an alkylthio group, an arylthio group, a lower alkyl group, a lower alkoxy group, an aryloxy group, an aryl group, a heterocyclic group or a nonmetallic atom group necessary to form a 5-, 6- or 7-membered ring by linking L₃₁ to L₃₂, L₃₂ to L₃₃ or L₃₃ to L₃₄; R₃₃ and R₃₄ are each an aliphatic group, provided that R₃₃ and L₃₁ or R₃₄ and L₃₄ may combine with each other to form a 5-, 6- or 7-membered ring structure; X₃₁ is an ion necessary to compensate for an intramolecular charge and q is the number of ions necessary to compensate for an intramolecular charge; R₄₁ to R₄₄ are each a hydrogen atom, an alkyl group or an aryl group; R₄₅ to R₅₂ are each a group capable of being substituted on a benzene ring, provided that R₄₅ and R_{46,} R₄₆ and R₄₇, R₄-1 and R_{48,} R₄₉ and R₅₀ R₅₀ and R₅₁ or R₅₁ and R₅₂ may combine with each other to form a ring structure, and R₄₇ is not an aryl group or a heterocyclic group;

In the formula (3), L₂₁ through L₃₄ are each a hydrogen atom, a halogen atom, an amino group, an alkylthio group, an arylthio group, a lower alkyl group, a lower alkoxy group, an aryloxy group, an aryl group, a heterocyclic group. Examples of a halogen atom include fluorine, chlorine, bromine and iodine; an amino group may be substituted or unsubstituted and specific examples thereof include amino, dimethylamino, diphenylamino and methyl-phenylamino; specific examples of an alkylthio group include methylthio, ethylthio and benzylthio; an arylthio group may be substituted or unsubstituted and specific examples thereof include phenylthio and m-fluorophenylthio; a lower alkyl group may be straight chain or branched, and having 5 or less carbon atoms and specific examples thereof include methyl, ethyl, propyl, butyl, pentyl and I-propyl; a lower alkoxy group is one having 4 or less carbon atoms and specific examples thereof include methoxy, ethoxy, propoxy and iso-propoxy; an aryloxy group may be substituted or unsubstituted and specific examples thereof include phenoxy, p-tolyloxy, and m-carboxyphenyloxy; an aryl group may be substituted or unsubstituted and specific examples thereof include m-phenyl, 2-naphthyl, 1-naphthyl, o-tolyl, o-methoxyphenyl, m-chlorophenyl, m-bromophenyl, p-tolyl, and p-ethoxyphenyl; a heterocyclic group may be 28 8013 substituted or unsubstituted and specific examples thereof include 2-furyl, 5-methyl-2-furyl, 2-thienyl, 2-imidazolyl, 2-methyl-1-imidazolyl, 4-phenyl-2-thiazolyl, 5-hydroxy-2-benzothiazolyl, 2-pyridyl and 1-pyrrolyl. These groups may be substituted by, for example, a phenyl group, a halogen atom, an alkoxy group or a hydroxy group. L₃₁ through L₃₄ are each preferably a hydrogen atom, a lower alkyl group, an aryl group or a heterocyclic group, more preferably a hydrogen atom, a methyl group or a phenyl group, and still more preferably a hydrogen atom.

L₃₁ through L₃₄ are also a nonmetallic atom group necessary to form a 5- to 7-membered ring by linking L₃₁ to L₃₂, L₃₂ to L₃₃ or L₃₃ to L₃₄, and specific examples of such a 5- to 7-membered ring include cyclopentene, cyclohexane, cycloheptene and decalin and these rings may be substituted by a lower alkyl group, a lower alkoxy group or an aryl group, as cited in L₂₁ through L₂₄ described above.

R₃₃ and R₃₄ are each an aliphatic group and examples of an aliphatic group include a straight chain or branched alkyl group having 1 to 30 carbon atoms (e.g., methyl, ethyl, propyl, butyl, pentyl, iso-pentyl, 2-ethyl-hexyl, octyl, decyl), an alkenyl group having 3 to 30 carbon atoms (e.g., 2-propenyl, 3-butenyl, 1-methyl-3-propenyl, 3-pentenyl, 1-methyl-3-butenyl, 4-hexenyl), and an aralkyl group having 7 to 30 carbon atoms (e.g., benzyl, phenethyl). R₃3 and R₃₄ are preferably a straight chain or branched alkyl group having 1 to 20 carbon atoms or an alkenyl group having 3 to 20 carbon atoms. These aliphatic groups may be substituted by substituents and such substituents are the same as defined in R₂₁ and R₂₂. R₃₃ and L₃₁, or R₃₄ and L₃₄ may combine with each other to form a 5- to 7-membered ring. Such a 5- to 7-membered ring is the same as a 5- to 7-membered ring formed by adjacent L₃₁ through L₃₄, as described above.

X₃₁ is an ion necessary to compensate for an intramolecular charge and is the same as defined in X₂₁ of the foregoing formula (2); q is the number of ions necessary to compensate for an intramolecular charge and is the same as defined in X₂₁ of the foregoing formula (2).

R₄₁ to R₄₄ are each a hydrogen atom, an alkyl group or an aryl group. An alkyl group is preferably one having 1 to 10 carbon atoms, such as methyl, ethyl, propyl, iso-propyl, butyl, tert-butyl, pentyl, neo-pentyl, 2-ethyl-hexyl, octyl, and decyl. Specific examples of an aryl group include phenyl, naphthyl, and anthranyl. R₄l to R₄₄ are preferably a hydrogen atom or an alkyl group, more preferably a hydrogen atom or a methyl group, and still more preferably a hydrogen atom.

These groups may be substituted and examples of a substituent are the same as cited in R₂₁ and R₂₂ R₄₅ to R₅₂ are each a group capable of being substituted on a benzene ring and specific examples thereof include an alkyl group (e.g., methyl, ethyl, butyl, iso-butyl), an aryl group (including a monocyle and a polycycle, e.g., phenyl, carboxyphenyl, p-tolyl, p-butylphenyl, naphthyl), a heterocyclic group (e.g., tetrahydrofuryl, 2-pyrrolidino-1-yl, thienyl, furyl, pyridyl, carbazolyl, pyrrolyl, indolyl), a halogen atom (e.g., fluorine, chlorine, bromine), a vinyl group, a trifluoromethyl group, an alkoxy group (e.g., methoxy, ethoxy, methoxyethoxy), an aryloxy group (e.g., phenoxy, p-tolyloxy), a sulfonyl group (e.g., methanesulfonyl, p-toluenesulfonyl), an alkoxycarbonyl group (e.g., ethoxycarbonyl, butoxycarbonyl), an amino group (e.g., amino, biscarboxy-methylamino), an acyl group (e.g., acetyl, benzoyl), an ureido group (e.g., ureido, 3-methylureido, 3-phenylureido), a thioureido group (e.g., thioureido, 3-methylthioureid), an alkylthio group (e.g., methylthio, ethylthio), an arylthio group (e.g., phenylthio), a sulfinyl group (e.g., methanesulfonyl, ethanesulfonyl, phenylsulfinyl), a hydroxyl group, a styryl group, and an acylamino group (e.g., acetylamino, benzoylamino). These groups may be substituted. R₄₅ to R₅₂ are preferably analkyl group, an aryl group, a heterocyclic group, a halogen atom, an alkylthio group or a sulfinyl group, more preferably a sulfinyl group, and specifically preferably, R₄₅ to R₅₂ are both a sulfinyl group. R₄₅ and R_{46,} R₄₆ and R₄₇, R₄₇ and R_{48,} R₄₉ and R₅₀, R₅₀ and R₅₁ or R₅₁ and R₅₂ may combine with each other to form a ring structure, provided that R₄₇ is not an aryl group or a heterocyclic group.

Representative examples of the compound of formula (2), which is hereinafter also denoted an infrared sensitizing dye or simply as IR dye, are shown below but are not limited to these.

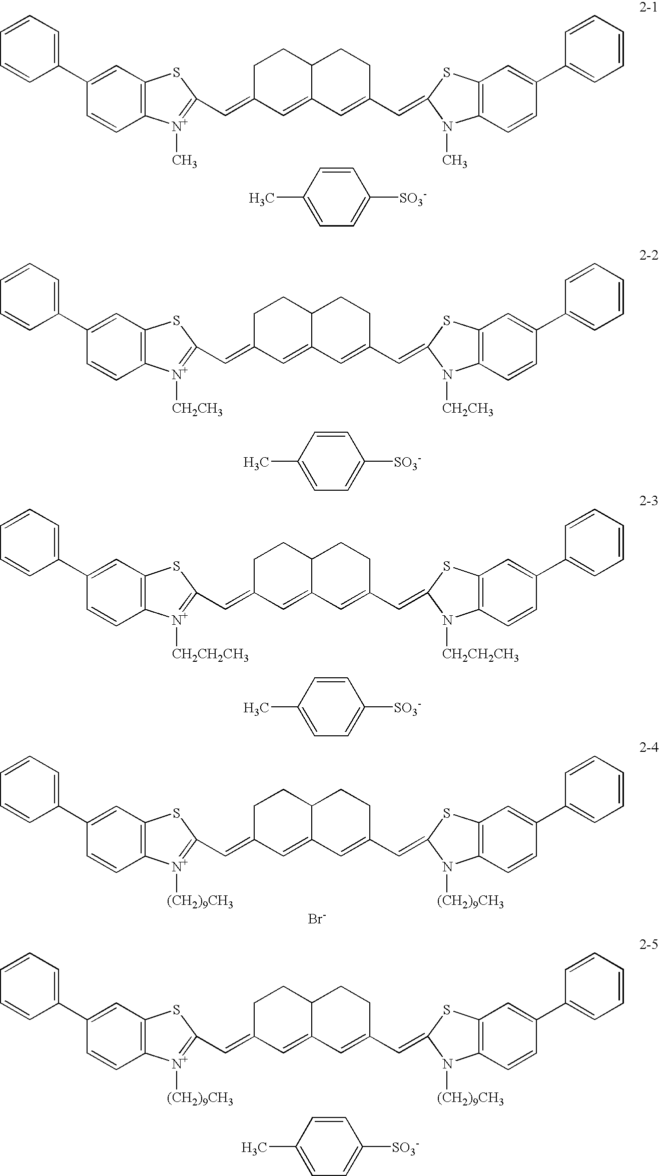

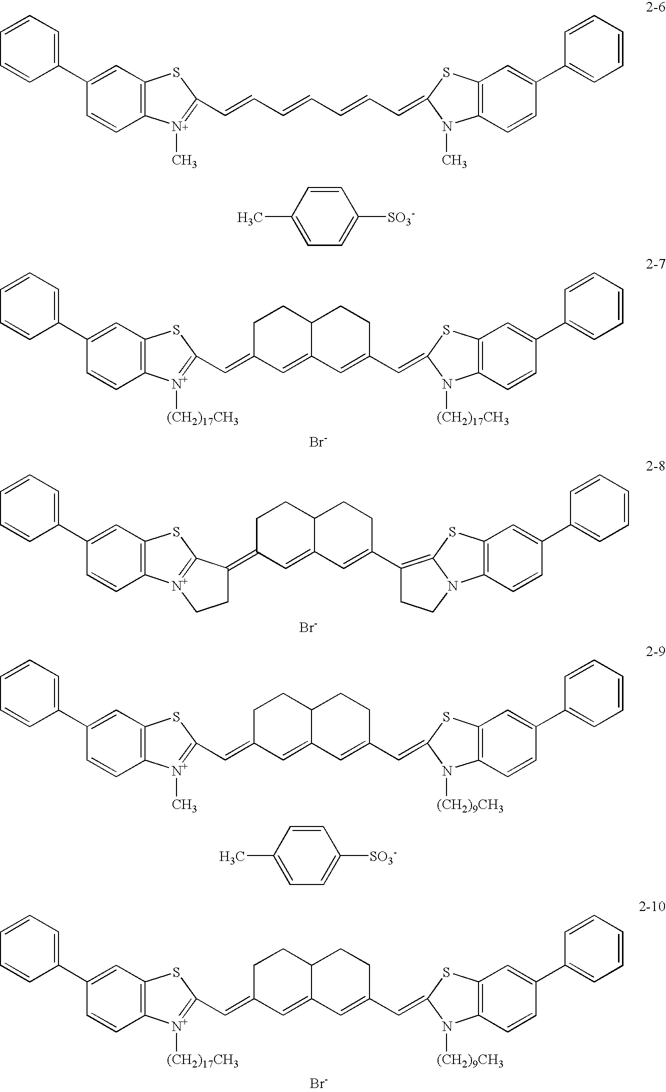

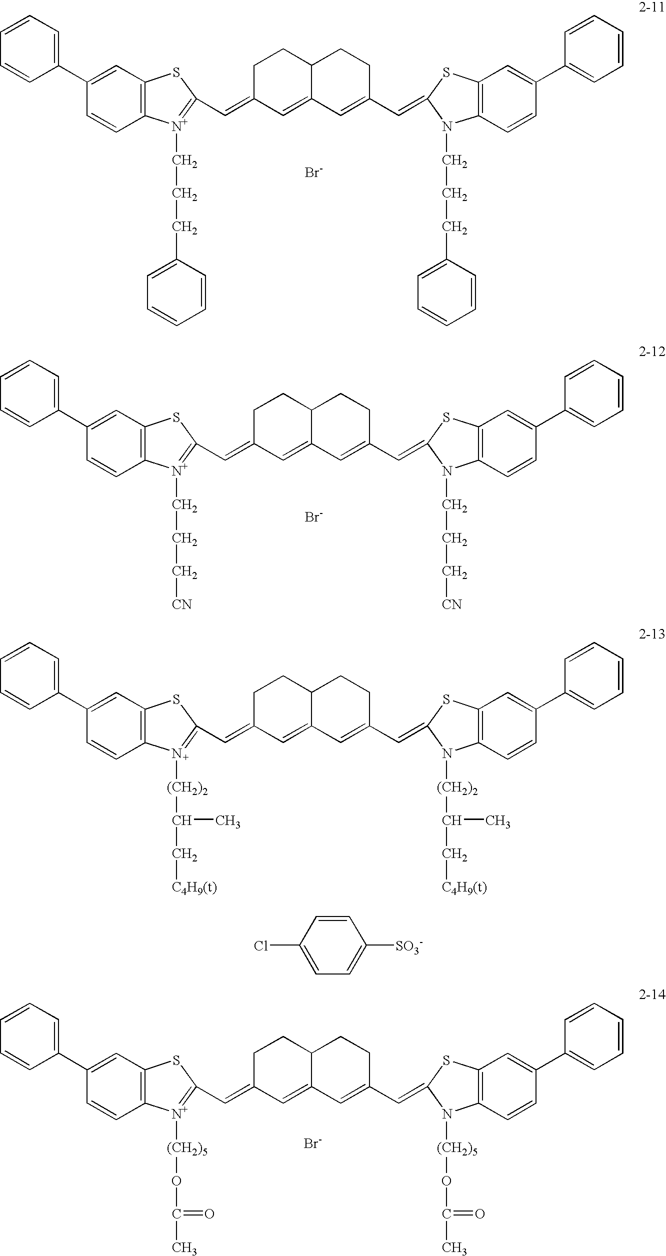

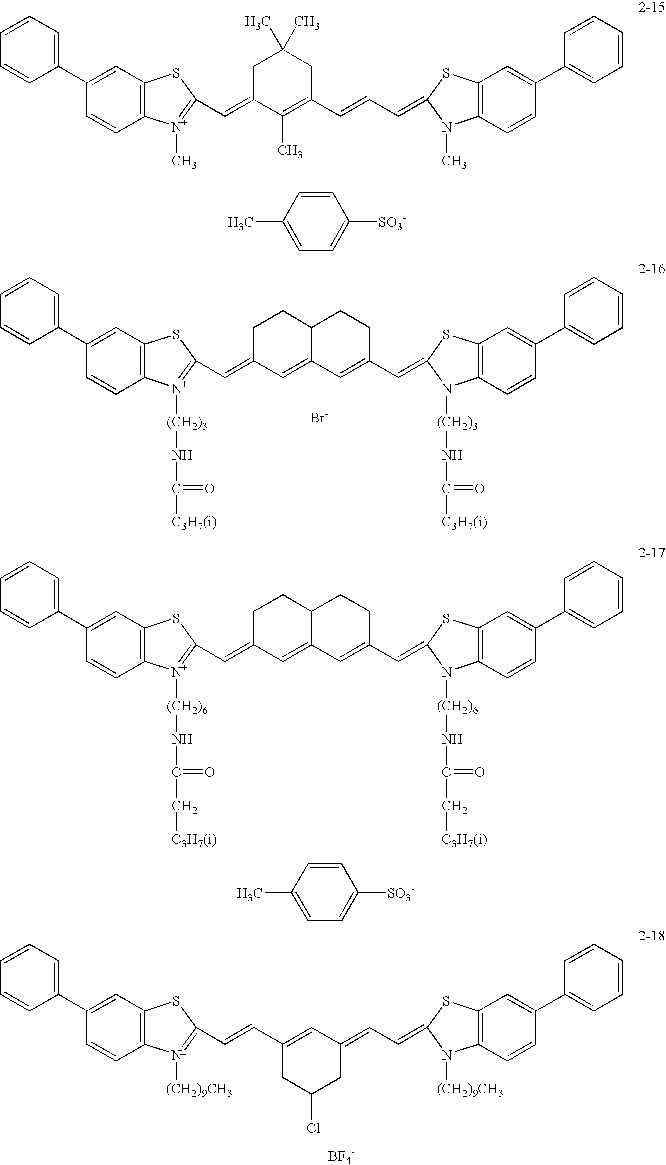

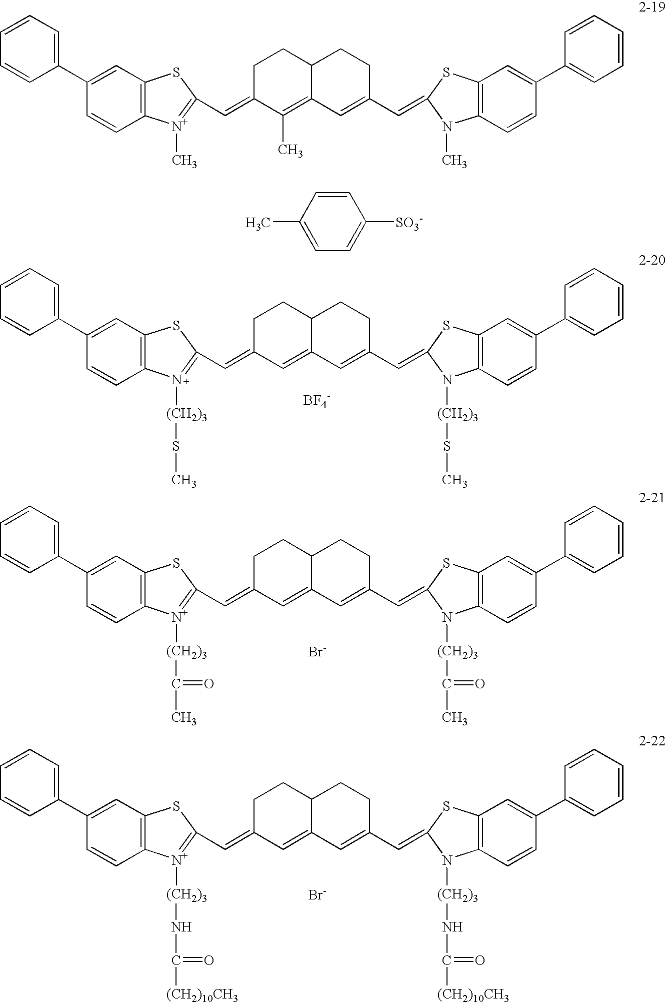

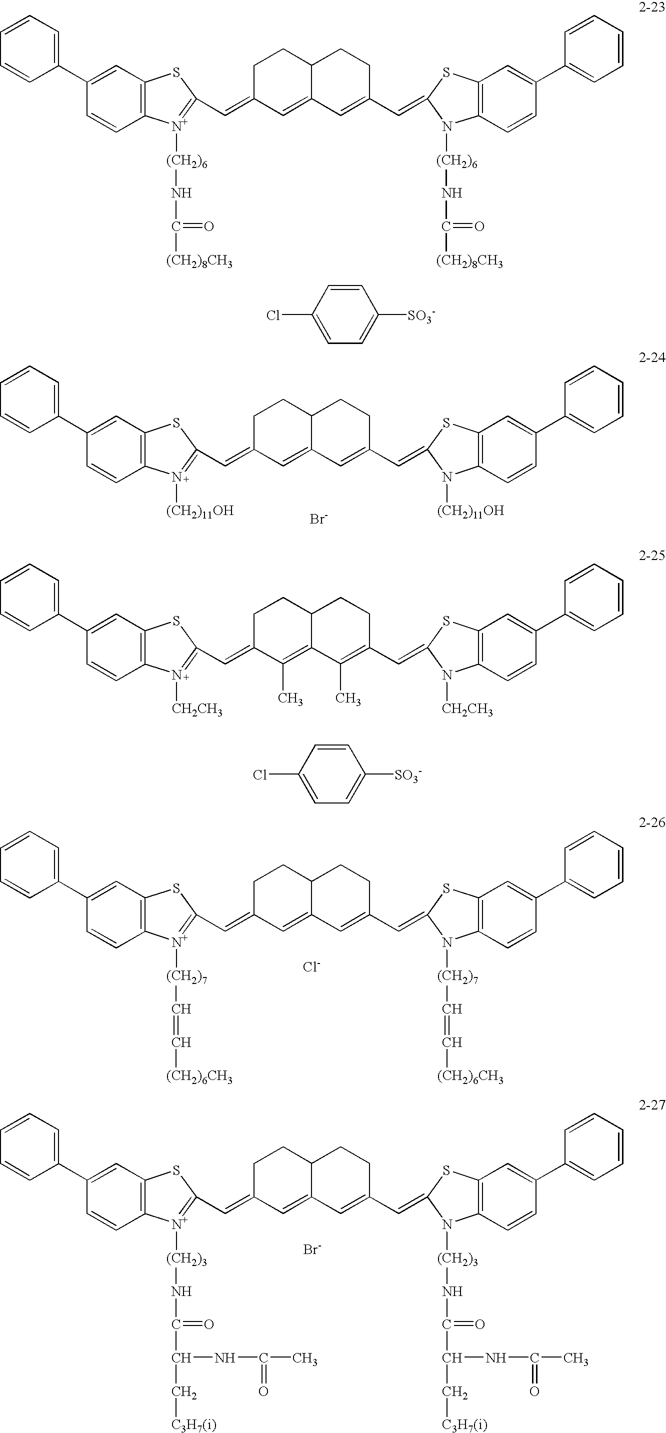

Representative examples of the compound of formula (3), which is hereinafter also denoted an infrared sensitizing dye or simply as IR dye, are shown below but are not limited to these.

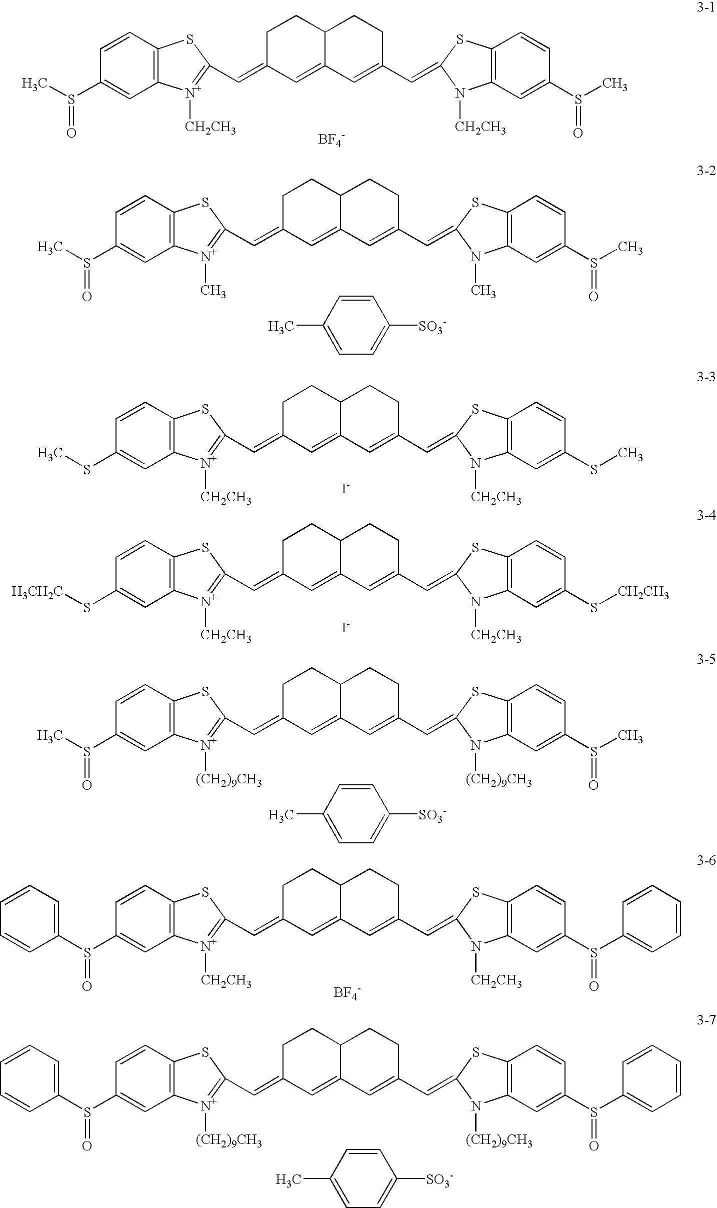

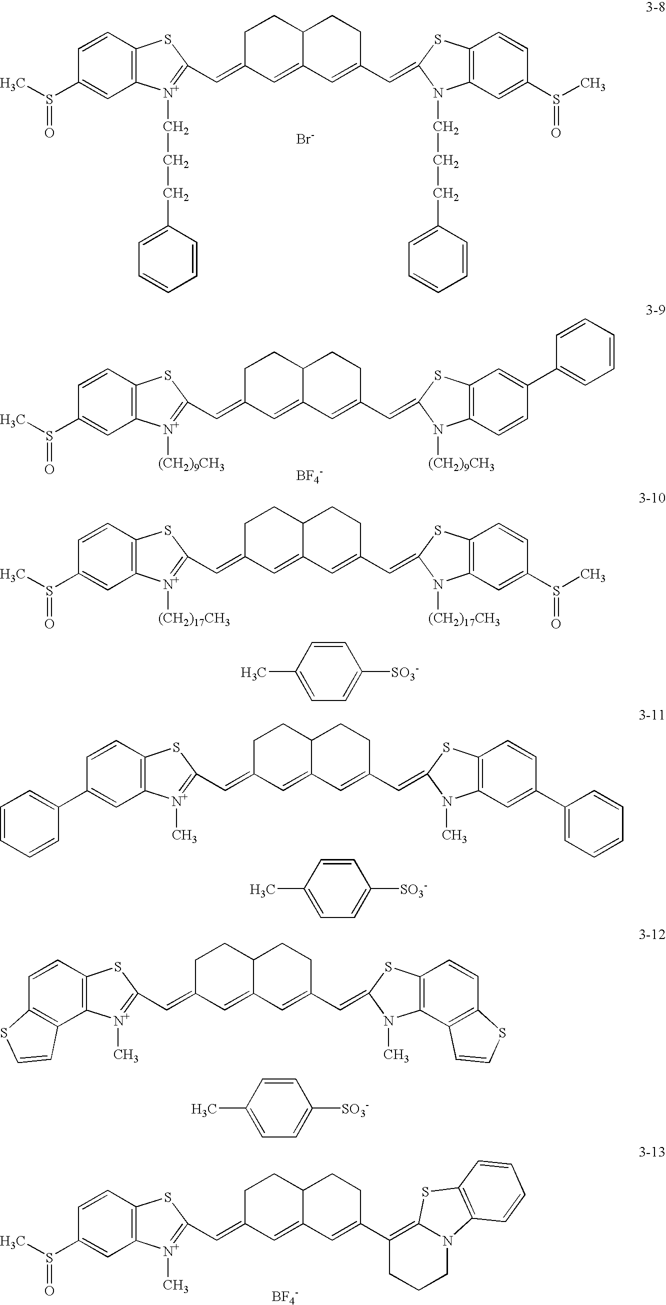

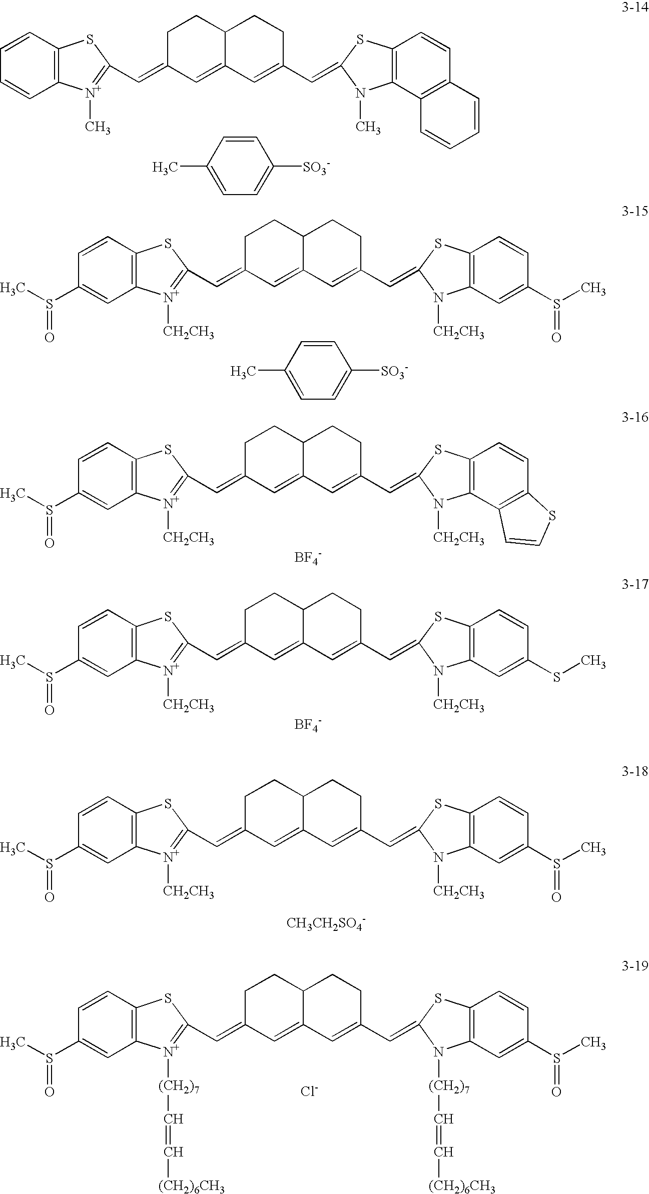

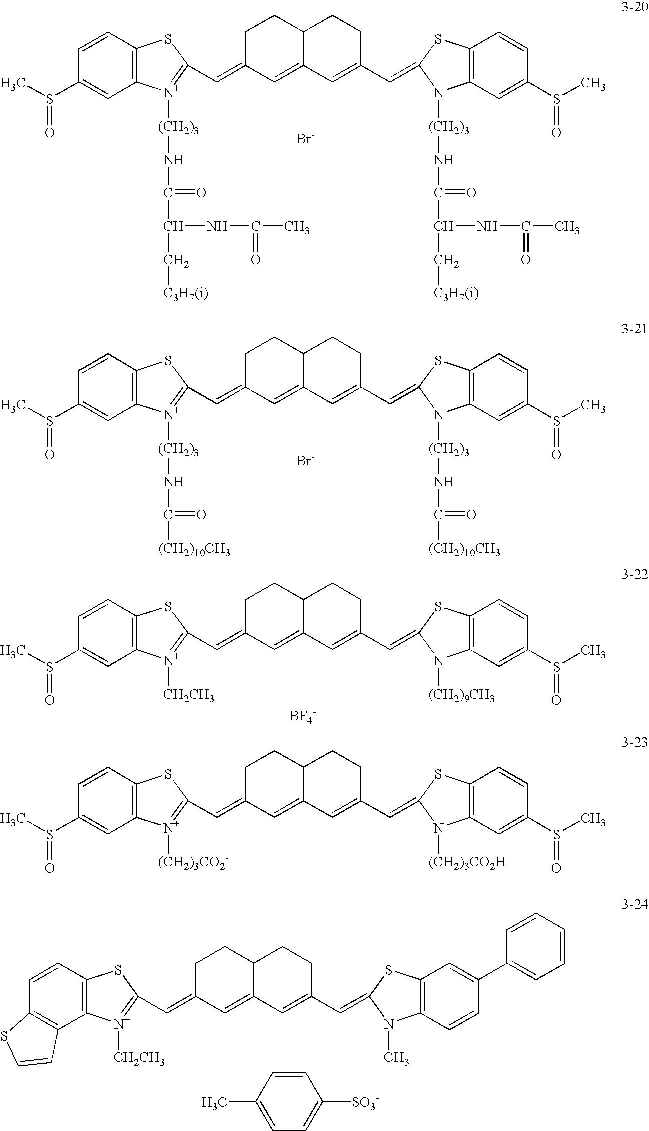

Infrared sensitizing dyes relating to the invention can be readily synthesized according to methods described in, for example, F. M. Hamer: The Chemistry of Heterocyclic Compounds vol. 18, The cyanine Dyes and Related Compounds (A. Weissberger ed. Interscience Corp., New York, 1964); J. Ber., 64, 1664-1674 (1931); Ukrain. Khim. Shur.; U.S. Pat. Nos. 2,320,439 and 2,398,999.

These infrared sensitizing dyes may be added at any time after preparation of silver halide. For example, they may be dissolved in a solvent or dispersed in the form of solid fine particles and added to silver halide grains or to a light-sensitive emulsion containing silver halide grains and organic silver salt grains. Alternatively, similarly to a heteroatom-containing compound adsorptive to silver halide grains, after added to silver halide grains and adsorbed thereto prior to chemical sensitization, chemical sensitization may be conducted, whereby scattering of chemical sensitization centers is prevented, leading to enhanced sensitivity and lowered fogging.

The sensitizing dyes may be added singly or in combination, preferably in a total amount of 1×10⁻⁶ to 5×10⁻³. more preferably 1×10⁻⁵ to 2.5×10⁻³ and still more preferably 4×10⁻⁵ to 1×10⁻³ mol per mol of silver halide.

Next, there will be described a photothermographic material of the invention.

An organic silver salt usable in the invention is a reducible silver source and an organic acid including a reducible silver ions. Organic acids usable in the invention include an aliphatic carboxylic acid, a carbocyclic carboxylic acid, heterocyclic carboxylic acid, and heterocyclic compounds. Of these, a long chain aliphatic carboxylic acid (having 10 to 30 carbon atoms, and preferably 15 to 25 carbon atoms) and a nitrogen-containing heterocyclic carboxylic acid are preferably used. An organic silver salt complex having a ligand exhibiting an overall stability constant for a silver ion of 4.0-10.0 is also useful. Examples of organic silver salts include those described in Research Disclosure (hereinafter, also denoted simply as RD) Nos. 17029 and 29963. Specifically, fatty acid silver salts are preferred and silver behenate, silver arachidate or silver stearate is more preferred.

Organic silver salt compounds can be obtained by mixing a water-soluble silver compound and a compound capable of forming a salt with silver, in which a normal mixing method, reversed mixing method or simultaneous mixing method is preferably employed. Controlled double-jet precipitation is also applicable, as described in JP-A No. 9-127643.

Organic silver salt grains usable in the invention exhibit an average grain size of 1 μm or less and are preferably monodisperse. The grain size of an organic silver salt grain refers to the diameter of a sphere having a volume equivalent to that of the grain when organic silver salt grains are in a spherical, bar-like or tabular form. The average grain size is preferably from 0.01 to 0.8 μm, and more preferably from 0.05 to 0.5 μm. The expression, monodisperse has the same meaning as in silver halide grains described later and the monodispersibility is preferably from 15 to 30%. More preferably, an organic silver salt used in the invention is comprised of monodisperse grains having an average grain size of 1 μm or less, thereby achieving enhanced image density. At least 60% of total organic silver salt grains is preferably accounted for by tabular grains. In the invention, the tabular grains refer to those exhibiting an aspect ratio (denoted as AR) of at least 3 and defined below:

AR=average grain size (μm)/grain thickness (μm). Organic silver salt grains are optionally subjected to preliminary dispersion together with a binder or a surfactant, pulverized and then dispersed preferably using a media dispersing machine or a high pressure homogenizer. Dispersing machines usable in the above-mentioned preliminary dispersion include, for example, a general use stirring machines of an anchor type, a propeller type or the like, a high-speed rotary centrifugal radiation-type stirrer (dissolver), and a high-speed rotary shearing type stirrer (homogenizer). Examples of the media dispersing machine include a rolling mill such as a ball mill, a planetary ball mill or a vibration mill, a medium-stirring mill such as a beads mill, an atriter, and a basket mill. Various types of high pressure homogenizers are also sable, for example, a type of colliding to a wall or plug, a type of dividing a stream of liquid and allowing the divided liquid streams to collide with each other at a high-speed and a type of passing through a thin orifice.

In devices used for dispersing organic silver salt rains usable in the invention, materials in contact with the organic silver salt grains are preferably ceramics such as zirconia, alumina, silicon nitride or boron nitride or diamond, and more preferably zirconia.

Organic silver salt grains preferably contain Zr in an amount of 0.01 to 0.5 mg per gram of silver, and more preferably 0.01 to 0.3 mg. Optimization of binder concentration, preliminary dispersion, operating conditions of a dispersing machine and the number of times for dispersion is preferable to obtain targeted organic silver salt grains. In order to minimize cloudiness after image formation and to attain excellent image quality, the lower the average grain size, the more preferred, and the average grain size of light-sensitive silver halide grains is preferably not less than 0.1 μm, more preferably 0.01 to 0.1 μm, and still more preferably 0.02 to 0.08 μm. The grain size refers to the diameter of a circle having an area equivalent to the area of the microscopically observed, individual grain, so-called circular equivalent diameter. Furthermore, silver halide grains are preferably monodisperse grains. The monodisperse grains as described herein refer to grains having a monodispersibility of grain size defined by the formula described below of not more than 40%; more preferably not more than 30%, still more preferably not more than 20%, and most preferably not more than 1%.

Monodispersibility of grain size=(standard deviation of grain diameter/average grain diameter)×100 (%)

There will be described silver halide (hereinafter, also denoted as light-sensitive silver halide or light-sensitive silver halide grains).

The grain form of silver halide is not specifically limited. In cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%, is more preferably at least 70%, and is still more preferably at least 80%. The ratio accounted for by the Miller index [100] face can be obtained based on T. Tani, J. Imaging Sci., 29, 165 (1985) in which adsorption dependency of a [111] face or a [100] face is utilized.

Tabular light-sensitive silver halide grains are also preferable in the invention. The tabular grains refer to those exhibiting an aspect ratio (denoted as r/h) of 3 or more, in which “r” is grain diameter (μm), represented as a square root of the projected area of the tabular grain and h is vertical thickness (μm). The aspect ratio is preferably from 3 to 50. The tabular grain diameter is preferably not more than 0.1 μm, and more preferably from 0.01 to 0.08 μm. Tabular silver halide grains are described in U.S. Pat. Nos. 5,264,337, 5,314,798 and 5,320,958 and objective tabular grains can be readily obtained.

The halide composition of silver halide is not specifically limited and may be any one of silver chloride, silver chlorobromide, silver iodochlorobromide, silver bromide, silver iodobromide and silver iodide. The silver halide grains used in the invention can be prepared according to the methods described in P. Glafkides, Chimie Physique Photographique (published by Paul Montel Corp., 1967; G. F. Duffin, Photographic Emulsion Chemistry (published by Focal Press, 1966); V. L. Zelikman et al., Making and Coating of Photographic Emulsion (published by Focal Press, 1964). Light-sensitive silver halide preferably includes metal ions selected from groups 6 to 11 inclusive of the periodic table of elements. The foregoing metal is preferably W, Fe, Co, Ni, Cu, Ru, Rh, Pd, Re, Os, Ir, Pt or Au.

The metal ions can be introduced into silver halide in the form of a metal complex or a metal complex ion. The metal complex or metal complex ion is preferably a six-coordinate metal complex represented by the following formula:

[ML₆]^{m}

wherein M represents a transition metal selected from elements in Groups 6 to 11 of the Periodic Table; L represents a coordinating ligand; and m represents 0, 1-, 2-, 3- or 4-. M is selected preferably from W, Fe, Co, Ni, Cu, Ru, Rh, Pd, Re, Os, Ir and Pt. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When an aquo ligand is present, one or two ligands are preferably coordinated. L may be the same or may be different.

M is preferably rhodium (Rh), ruthenium (Ru), rhenium (Re), iridium (Ir) or osmium (Os). Specific examples of a transition metal complex ion include

[RhCl₆]³⁻, [RuCl₆]³⁻, [ReCl,]³⁻, [RuBr₆]³⁻, [OsCl₆]³⁻, [CrCl₆]⁴⁻, [IrCl₆]⁴⁻, [IrCl₆]³⁻. [Ru(NO)Cl]²⁻, [RuBr₄(H₂O)]²⁻, [Ru(NO)(H₂O)Cl₄]⁻, [RhCl₅(H₂O)]²⁻, [Re(NO)Cl₅]²⁻, [Re(NO)(CN)₅]²⁻, [Re(NO)Cl(CN)₄]², [Rh(NO)₂Cl₄]⁻, [Rh(NO)(H₂O)Cl₄], [Ru(NO)(CN)₅]²⁻, [Fe(CN)₆]³⁻, [Rh(NS)Cl₅]²−, [Os(NO)Cl₅]²⁻, [Cr(NO)Cl]²⁻, [Re(NO)Cl₅]⁻, [Os(NS)Cl₄(TeCN)]²⁻, [Ru(NS)Cl₅]²⁻, [Re(NS)Cl₄(SeCN)]²⁻, [OS (NS)Cl(SCN)₄]^{2 -} and [Ir(NO)Cl₅]²⁻.

The foregoing dopants may be used alone or in combination thereof. The dopant content is preferably 1×10⁻⁹ to 1×10⁻² mol and more preferably 1×10⁻⁸ to 1×10⁻⁴ mol per mol of silver.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, they are preferably added at the stage of nuclei formation, growth, and physical ripening; furthermore, they are preferably added at the stage of nuclei formation and growth; and are most preferably added at the stage of nuclei formation.

These compounds may be added several times by dividing the total added amount. Uniform content in the interior of a silver halide grain can be carried out. As disclosed in JP-A No. 63-29603, 2-306236, 3-167545, 4-76534, 6-110146 and 5-273683, the metal can be non-uniformly occluded in the interior of the grain. These metal compounds can be dissolved in water or a suitable organic solvent (e.g., alcohols, ethers, glycols, ketones, esters, amides, etc.) and then added. Furthermore, there are methods in which, for example, an aqueous solution of a powdered metal compound or an aqueous solution in which a metal compound is dissolved along with NaCl and KCl is added to a water-soluble silver salt solution during grain formation or to a water-soluble halide solution; when a silver salt solution and a halide solution are simultaneously added, a metal compound is added as a third solution to form silver halide grains, while simultaneously mixing the three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous solution of a powdered metal compound or an aqueous solution in which a metal compound is dissolved along with NaCl and KCl is added to a water-soluble halide solution. When the addition is carried out onto grain surfaces, an aqueous solution comprising the necessary amount of a metal compound can be placed in a reaction vessel immediately after grain formation, or during physical ripening, at the completion thereof or during chemical ripening.

Silver halide grain emulsions used in the invention may be desalted after the grain formation, using the methods known in the art, such as the noodle washing method or flocculation process.

Silver halide grains are preferably chemically sensitized. Commonly known sulfur sensitization, selenium sensitization or tellurium sensitization is applicable as preferred chemical sensitization. There is also applicable 50 8013 noble metal sensitization using gold compounds or platinum, palladium or iridium compounds, or reduction sensitization.

Compounds known in the art are usable in the above-mentioned sulfur sensitization, selenium sensitization or tellurium sensitization, as described in, for example, JP-A No. 7-128768. Examples of a tellurium sensitizer include diacyltellurides, bis(oxycarbonyl)tellurides, bis(carbamoyl)tellurides, diacyltellurides, bis(oxycarbonyl)ditellurides, bis(carbamoyl)ditellurides, P=Te bond-containing compounds, tellurocarboxylates, Te-organyltellurocarboxylic acid esters, di(poly)tellurides, tellurides, tellurols, telluroacetals, tellurosulfonates, P-Te bond-containing compounds, Te-containing compounds, tellurocarbonyl compounds, inorganic tellurium compounds and colloidal tellurium.

Examples of preferred compounds usable in noble sensitization include chloroauric acid, potassium chloaurate, potassium aurithiocyanate, gold sulfide, gold selenide, or the compounds described in U.S. Pat. No. 2,448,060 and British Patent No. 618,061.

Compounds usable in reduction sensitization include, for example, tin(II) chloride, aminoiminomethanesulfinic acid, hydrazine derivatives, borane compounds, silane compounds and polyamine compounds as well as ascorbic acid and thiourea dioxide. Reduction sensitization can also be achieved by ripening a silver halide emulsion, while maintaining the emulsion at a pH of 7 or more, or at a pAg of 8.3 or less. Reduction sensitization can also be performed by introduction of a single addition of silver ions during grain formation.

Subsequently, other constituent elements of the photothermographic material of the invention will be further described.

The photothermographic material comprises on a support a light sensitive layer containing an organic silver salt, as described above, light-sensitive silver halide and a reducing agent and a protective layer in this order set forth. Further, an interlayer may optionally be provided between the light-sensitive layer and the protective layer.

In order to secure transportability or to prevent blocking onto the protective layer, a backing layer may be provided on the opposite side of the support to the light-sensitive layer. The respective layers described above, each may comprises a single layer or different two or more layers.

Preferably, a binder resin is employed to form each of the above-mentioned layers. The binder resin can be chosen from conventionally used transparent or translucent binder resins. Examples of such binder resins include polyvinyl acetal resin such as polyvinyl formal, polyvinyl acetoacetal or polyvinyl butyral; cellulose resin such as ethyl cellulose, hydroxyethyl cellulose or cellulose acetobutyrate; styrene resin such as polystyrene, styrene/acrylonitrile copolymer or styrene/acrylonitrile/acryl rubber copolymer; vinyl chloride resin such as polyvinyl chloride or poly(chlorinated propylene); polyester; polyurethane; polycarbonate; polyallyrate, epoxy resin and acryl resin. The resin may be used singly or in combination thereof.

The above-mentioned binder resin may appropriately be used in the protective layer, the interlayer or an optional backing layer. In the interlayer or backing layer, an epoxy resin or acryl monomer capable of polymerizing upon exposure to actinic rays may be used as a layer-forming binder resin. In the invention, aqueous-based binder resins described below is also preferable. Thus, a water-soluble polymer or water-dispersible hydrophobic polymer (latex) is usable. Examples thereof include polyvinylidene chloride, vinylidene chloride/acrylic acid copolymer, vinylidene chloride/itaconic acid copolymer, poly(sodium acrylate), polyethylene oxide, acrylic acid amide/acrylic acid ester copolymer, styrene/maleic acid anhydride copolymer, acrylonitrile/butadiene copolymer, vinyl chloride/vinyl acetate copolymer and styrene/butadiene/acrylic acid copolymer. These constitute a water-based coating solution, which is coated and dried to form a uniform resin layer. The foregoing polymer is used, for example, in such a manner that an aqueous dispersion comprised of an organic silver salt, silver halide, reducing agent and the like is mixed with the polymer (latex) and the obtained dispersion is coated and dried to form a thermally developable light-sensitive layer. Drying melts particulate latex to form a uniform layer. The polymer preferably exhibits a glass transition point of -20 to 80° C., and more preferably −5 to 60° C. A higher glass transition temperature results in a rise in thermal development temperature and a lower glass transition point often causes fogging, resulting in reduced sensitivity or a decrease in contrast. An aqueous polymer dispersion is preferably comprised of particles having an average particle size of 1 nm to several μms. A water-dispersible hydrophobic polymer is generally called a latex, which is preferably used as a binder for water-based paints in terms of enhanced water resistance. The amount of latex to achieve water resistance as a binder is determined by taking into account coatability, but the more is more preferred in terms of moisture resistance. The weight ratio of latex to the total binder is preferably 50% to 100%, and more preferably 80% to 100%.

The binder content is preferably 0.25 to 10 times the silver coverage, for example, when the silver coverage is 2.0 g/m², the polymer coverage is preferably 0.5 to 20 g/m². More preferably, the binder content is 0. 5 to 7 times silver coverage and, for example, when the silver coverage is 2.0 g/m², the polymer coverage is more preferably 1.0 to 14 g/m². A binder content of less than 0.25 times the silver coverage often markedly deteriorates silver image color to a level unacceptable to practice, and a binder content of more than 10 times the silver coverage results in a decrease in contrast to a level unacceptable in practice.

In addition to the above-mentioned essential constituents and binder resin, the light-sensitive layer may optionally contain additives such as an antifoggant, an image toning agent, a sensitizing dye and supersensitizing material (also called supersensitizer).

Antifoggants are appropriately chosen, including, for example, a heterocyclic compound containing at least one substituent represented by formula of —C(X1)(X2)(X3) in which X1 and X2 are each a halogen atom and X3 is a hydrogen atom or a halogen atom, as described in U.S. Pat. Nos. 3,874,946 and 4,756,999 and compounds described in JP-A Nos. 9-288328 and 9-90550; and U.S. Pat. No. 5,028,523 and European patent Nos. 600,587, 605,981 and 631,176. The content is preferably 0.25 to 10 times silver coverage, for example, when the silver coverage is 2.0 g/m², the polymer coverage is preferably 0.5 to 20 g/m².

Examples of an image toning agent to modify image color include imides (e.g., phthalimide), cyclic imides, pyrazoline-5-ones, quinazoline (e.g., succimide, 3-phenyl-2-pyrazoline-5-one, 1-phenylurazole, quinazoline, 2,4-thiazolidine-one); naphthalimides (e.g., N-hydroxy-1,8-naphthalimide); cobalt complexes (e.g., hexaaminetrifluoroacetate of cobalt), mercaptans (e.g., 3-mercapto-1,2,4-triazole); N-(aminomethyl)aryldicarboxyimides (e.g., N-(dimethylaminomethyl)phthalimisw); blocked pyrazoles, isothiuronium derivatives and their combination with some light-bleaching agents (e.g., N,N′-hexamethylene(1-carbamoyl-3,5-dimethylpyrazole), 1,8-(3,6-dioxaoctane)bis(isothiuroniumtrifluoroacetate) and its combination with 2-(tribromomethylsulfonium)benzothiazole), merocyanine dyes (e.g., 3-ethyl-5-((3-ethyl-2-benzothiazolinilydene(benzothiazolinidene)-2-thio-2,4-oxazolidinedione); phthalazine, phthalazine derivatives and their metal salts (e.g., 4-(1-naphthyl)phthalazinone, 6-chlorophthalazinone, 5,7-dimethyloxyphthalazinone, 2,3-dihydroxy-1,4-phthalazinedione); combination of phthalazinone and sulfinic acid derivatives (e.g., 6-chlorophthalazinone+benzenesulfinic acid sodium salt, 8-methylphthalzinone+p-trisulfonic acid soldium salt); combination of phthalazine and phthalic acid; combination of phthalazines (including phthalazine adduct) and at least one selected from maleic acid anhydride, phthalic acid, 2,3-naphthalenedicarboxylic acid and o-phenylenic acid derivative or its anhydride (e.g., phthalic acid, 4-methylphthalic acid, 4-nitrophthalic acid, tetrachlorophthalic acid anhydride);quinazolinediones, benzoxazine, orthoxazine derivatives; benzoxazine-2,4-diones (e.g., 1,3-benzoxazine-2,40dione); pyrimidines and asymmetric triazines (e.g., 2,4-dihydroxypyrimidine), and tetraazapentalene derivatives (e.g., 3,6-dimercapto-1,4-diphenyl-1H,4H-2,3a,5,6a-tetrazapentalene). Preferred image toning agents are phthalazone and phthalzine. The image toning agent may be incorporated to a protective layer within the range not vitiating the effect of the invention.

Supersensitizers are chosen from those described in RD17643, JP-B Nos. 9-155000 and 43-4933 and JP-A 59-19032, 59-192242 and 5-341432. In the invention, an aromatic heterocyclic mercapto compound represented by the following formula (M) and disulfide compound represented by the following formula (Ma) which substantially release the foregoing mercapto compound are usable as a supersensitizer:

Ar—SM formula (M)

Ar—S—S—Ar formula (Ma)

In formula (M), M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included. In formula (Ma), Ar is the same as defined in formula (M).

The aromatic heterocyclic rings described above may be substituted with a halogen atom (e.g., Cl, Br, I), a hydroxy group, an amino group, a carboxy group, an alkyl group (having one or more carbon atoms, and preferablyl 1 to 4 carbon atoms) or an alkoxy group (having one or more carbon atoms, and preferablyl 1 to 4 carbon atoms). The supersensitizer is incorporated into a light-sensitive layer containing organic silver salt and silver halide grains, preferably in an amount of 0.001 to 1.0 mol, and more preferably 0.01 to 0.5 mol per mol of silver.

A heteroatom containing a macrocyclic compound may be incorporated in the light-sensitive layer. At least a 9-membered macrocyclic compound containing at least a heteroatom selected from nitrogen, oxygen, sulfur and selenium atoms is preferred, 12- to 24-membered one is more preferred and a 15- to 21-membered one is still more preferred. Representative compounds are crown ethers, which were synthesized by C. J. Pederson in 1967. Since then, a number of compounds were synthesized. These compounds are described in C. J. Pederson, Journal of American Chemical Society vol. 86, (2495), 7017-7036 (1967); G. W. Gokel, S. H. Korzeniowski, “Macrocyclic Polyether Synthesis” Springer-Verlag (1982).

In addition to the above-mentioned additives, for example, a surfactant, an antioxidant, a stabilizer, a plasticizer, UV absorber and a coating aid may be incorporated to the light-sensitive layer. Additives including the above-mentioned ones are described in RD17029 (June 1978, pages 9-15).

The light-sensitive layer may be composed of a single layer or different plural layers having the same composition. The light-sensitive layer is usually 10-30 μm thick.

In the photothermographic material of the invention, to control the amount or wavelength distribution of light transmitting the light-sensitive layer, a filter layer may be provided on the light-sensitive layer side or on the opposite side thereto, or a dye or a pigment may be incorporated in the light-sensitive layer.

Commonly known compounds which are capable of absorbing light in the various wavelength region in accordance with spectral sensitivity of the photothermographic material, are usable as a dye usable in the invention. For example, when the photothermographic material is used as an image recording material utilizing infrared radiation, it is preferable to employ squalilium dyes having a thiopyrylium nucleus (hereinafter referred to as thiopyriliumsqualilium dyes) and squalilium dyes having a pyrylium nucleus (hereinafter referred to as pyryliumsqualilium dyes), as described in Japanese Patent Application No. 11-255557, and thiopyryliumcroconium dyes or pyryliumcroconium dyes which are analogous to the squalilium dyes. Incidentally, the compounds having a squalilium nucleus, as described herein, refers to ones having 1-cyclobutene-2-hydroxy-4-one in their molecular structure. Herein, the hydroxyl group may be dissociated.

A support and a protective layer, which are essential for layer constitution of the photothermographic material, will be described in the following.

Resin film of, for example, poly(acrylic acid ester), poly(methacrylic acid ester), polyethylene terephthalate, polybutylene terephthalate, polyethylene naphthalate, polycarbonate, polyacrylate, polyvinyl chloride, polyethylene, polypropylene, polystyrene, nylon, poly(aromatic amide), polyether ether ketone, polysulfone, polyether sulfone, polyimide, poly(ether imide), or triacetyl cellulose is used as a support of the photothermographic material. Multilayer film of the foregoing resin is also usable.

In the image recording process related to the invention, after formation of latent image, the support is subjected to thermal development to form images, so that stretched and heat-set film is preferable in terms of dimensional stability. Fillers such as titanium oxide, zinc oxide, barium sulfate or calcium carbonate may be incorporated within a range not to inhibit effects of the invention. The support thickness is usually 10 to 500 μm, and preferably 25 to 250 μm.

Binder resin described in the afore-mentioned light-sensitive layer may optionally be employed in the protective layer of the photothermographic material.

With respect to additives in the protective layer, incorporation of fillers is preferable for scratch prevention of an image after thermal development or to maintain transportability. A filler is incorporated preferably in an amount of 0.05% to 30% by mass of the layer-forming composition.

In order to improve lubrication or antistatic properties, lubricants or antistatic agents may be incorporated into the protective layer. Examples of a lubricant include a fatty acid, fatty acid ester, fatty acid amide, polyoxyethylene, polyoxypropylene, (modified) silicone oil, (modified) silicone resin, fluororesin, fluorinated carbon and wax. Examples of an antistatic agent include a cationic surfactant, anionic surfactant, nonionic surfactant, polymeric antistatic agent, metal oxide, conductive polymer, compounds described in “11290 Chemical Products” Kagaku Kogyo Nippo-sha, page 875-876, and compounds described in U.S. Pat. No. 5,244,773, col. 14-20. Various additives for the light-sensitive layer may be incorporated into the protective layer within the range not to inhibit advantageous effects of the invention. Such additives are incorporated preferably in an amount of 0.01% to 20% by mass of the protective layer composition, and more preferably 0.05% to 10%.

The protective layer may be a single layer or composed of plural layers which are different or identical in composition. The protective layer thickness is preferably 1.0 to 5.0 μm.

In addition to the above-mentioned light-sensitive layer, support and protective layer, there may be provided an interlayer for improvement of adhesion of the light-sensitive layer onto the support or a backing layer for the purpose of enhancing transportability or preventing static electricity. The interlayer thickness is preferably from 0.05 to 2.0 μm and the backing layer thickness is preferably from 0.1 to 10 μm.

A coating solution for the light-sensitive layer, a coating solution for the protective layer and a coating solution for an interlayer or backing layer to be optionally provided are each prepared by dissolving or dispersing the respective constituents described above in an appropriate solvent.

There may be usable any solvent which exhibits a solubility parameter of 6.0 to 15.0, as described in “Yozai Pocket Book” (Solvent Pocket Book), edited by Yukigosei Kagaku Kyokai. Examples of such a solvent usable in the foregoing coating solutions include ketones such as acetone, isophorone, ethyl amyl ketone, methyl ethyl ketone and methyl isobutyl ketone; alcohols such as methyl alcohol, ethyl alcohol, n-propyl alcohol, isopropyl alcohol, n-butyl alcohol, isobutyl alcohol, diacetone alcohol, cyclohexanol and benzyl alcohol; glycols such as ethylene glycol, diethylene glycol, triethylene glycol, propylene glycol, and hexylene glycol; ether alcohols such as ethylene glycol monomethyl ether and diethylene glycol monoethyl ether; ethers such as ethyl ether, dioxane, and isopropyl ether; esters such as ethyl acetate, butyl acetate, amyl acetate and isopropyl acetate; hydrocarbons such as n-pentane, n-hexane, n-heptane, cyclohexane, benzene, toluene and xylene; chlorides such as methyl chloride, chloromethylene, chloroform and dichlorobenzene. These solvents may be used singly or in combinations thereof. The residual solvent amount in the photothermographic material can be controlled by optimally setting temperature conditions in the stage of drying after coating. The overall residual solvent amount is preferably from 5 to 1,000 mg/m² and more preferably 10 to 300 mg/m².

When dispersing is needed in the preparation of the respective coating solutions, commonly known dispersing machines are usable, such as a two-roll mill, a three-roll mill, a ball mill, a pebble mill, a cobol mill, a trone mill, a sand grinder, Sqegvari atriter, a high-speed impeller dispersing machine, a high-speed stone mill, a high-speed impact mill, disper, a high-speed mixer, homogenizer, an ultrasonic dispersing machine, an open kneader or a continuous kneader.

The respective coating solutions can be coated by using commonly known coaters, for example, an extrusion coater, a reverse roll coater, a gravure coater, an air-doctor coater, a blade coater, an air-knife coater, a squeeze coater, a dip coater, a bar coater, a transfer roll coater, a kiss coater, a cast coater and a spray coater of these coaters, to minimize unevenness in coated layer thickness, an extrusion coater or a roll coater, for example, a reverse roll coater is preferred.

Any protective layer is applicable if it causes no damage to the light-sensitive layer. In cases when a solvent contained in a coating solution of the protective layer possibly dissolves the light-sensitive layer, using an extrusion coater or a gravure roll coater is preferred. When using a contact-coating method such as a gravure roll coater or a bar coater, the direction of rotation of a gravure roll or a bar may be normal rotation or reverse rotation to the direction of travel. In the case of normal rotation, it may be equal or different in circumferential speed.

To form the respective constituent layers, coating and drying may be repeated for each of the layer. Alternatively, simultaneous multilayer coating is performed in a wet-on-wet system, followed by being dried, in which coating is performed by the combination of an extrusion coater with a reverse roll coater, a gravure roll coater, an air doctor coater, a blade coater, an air knife coater, a squeeze coater, a dip coater, a bar coater, a transfer roll coater, a kiss coater, a caster coater or a spray coater. In the simultaneous multilayer coating in a wet-on-wet system, the upper layer is coated on the lower layer in a wet state, thereby resulting in enhanced adhesion between the upper and lower layers.

After coating a coating solution of the light-sensitive layer, the coated layer is dried preferably at a temperature of from 65 to 100° C. to achieve an object of the invention. A drying temperature of less than 65° C. leads to incomplete reaction and aging change in sensitivity often results. A drying temperature of more than 100° C. often causes fogging (coloring) in a photothermographic material immediately after preparation. The drying, depending on the air quantity during drying, is preferably within the range of 2 to 30 min.

Immediately after coating, drying may be conducted at a temperature within the range described above. Alternatively, to prevent unevenness (yuzu orange skin) caused by Marangoni effect of a coating solution in drying or caused by the surface being initially dried by hot air, the initial drying is conducted at a temperature lower than 65° C., followed by drying at a temperature within the above-described range.

The photothermographic material of the invention and a suitable preparation method thereof can realize the object of the invention. Further, optimization of an image forming method can obtain clear images without causing interference fringes.

Subsequently, an image recording method suitable for the photothermographic material of the invention will be described below.

The image recording method applicable in the invention is mainly divided to three embodiments according to the angle between the exposed surface and laser beam, the wavelength of laser and the number of lasers and may be performed by a single embodiment thereof or the combination of two or more embodiments. Performing such a image recording method can obtain a clear image having no interference fringe.

In one suitable embodiment of the image recording method of the invention, image formation is performed by scanning exposure using a laser light in which the angle between the surface of a photothermographic material and the laser beam does not substantially become vertical. Deviating the incident light angle from the verticality of laser beam incident angle increases an optical path difference at the light-sensitive layer and even when reflection light is produced at the interface between layers, scattering or attenuation occurs in the optical path of laser light, rendering it difficult to cause interference fringes. “Does not substantially become vertical”, as described herein, means that during laser scanning, the nearest vertical angle is preferably from 55 to 88 degrees, is more preferably from 60 to 86 degrees, and is still more preferably from 65 to 84 degrees.

In further preferred embodiment of the image recording method, image formation is performed by scanning exposure using laser beam in a longitudinal multiple mode in which the exposure wavelength is not single. Scanning by using laser beam in a longitudinal multiple mode having a width in exposure wavelength reduces generation of interference fringes, as compared to scanning laser light of a longitudinally single mode. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

In the image recording method related to the invention, lasers usable in the scanning exposure include, for example, a solid laser such as a ruby laser, YAG laser or glass laser; a gas laser such as He—Ne laser, Ar laser, Kr laser, CO₂ laser, CO laser, He—Cd laser, N₂ laser or excimer laser: a semiconductor laser such as InGaP laser, AlGaAs laser, GaAsP laser, InGaAs laser, InAsP laser, CdSnP₂ laseror GaSb laser; a chemical laser and a dye laser. These are appropriately chosen according to the use thereof but in the image recording method related to the invention, a semiconductor laser having a wavelength of 600 to 1200 nm is preferred in terms of maintenance and size of a light source.

When scanned on a photothermographic material using a laser imager or a laser image setter, the beam diameter on the exposed surface of the photothermographic material is usually from 5 to 75 Mm and the minor axis and the main axis diameter are from 5 to 75 μm and from 5 to 100 μm, respectively. The laser light scanning speed can be optimally set for every photothermographic material, according to the sensitivity of the photothermographic material at a laser oscillating wavelength and the laser power.

### EXAMPLES

The present invention is explained in more detail with reference to the following examples, but the present invention should not be construed as being limited thereto. In examples, “%” and “part(s)” mean % by mass and part(s) by mass, unless otherwise noted.

### Example 1

### Preparation of Subbed Photographic Support:

Both surfaces of a commercially available biaxially stretched thermally fixed, blue-tinted 175 μm PET film, which exhibited an optical density of 0.170 (determined by densitometer PDA-65, produced by Konica Minolta Corp.), was subjected to corona discharging at 8 w/m²·min. Onto one side thereof, the subbing coating composition a-1 descried below was applied so as to form a dried layer thickness of 0.8 μm, which was then dried. The resulting coating was designated Subbing Layer A-1. Onto the opposite side, the subbing coating composition b-1 described below was applied to form a dried layer thickness of 0.8 μm. The resulting coating was designated Subbing Layer B-1.

Subbing layer coating composition a-1

| | | |
|---|---|---|
| Latex solution (solid 30%) of | 270 | g |
| a copolymer consisting of butyl acrylate | | |
| (30 weight %)/t-butyl acrylate (20 weight %)/ | | |
| styrene (25 weight %)/2-hydroxy | | |
| ethyl acrylate (25 weight %) | | |
| (C-1) | 0.6 | g |
| Hexamethylene-1,6-bis(ethyleneurea) | 0.8 | g |
| Water to make | 1 | liter |

Subbing layer coating composition b-1

| | | |
|---|---|---|
| Latex liquid (solid portion of 30%) | 270 | g |
| of a copolymer consisting of | | |
| butyl acrylate (40 weight %)/ | | |
| styrene (20 weight %)/ | | |
| glycidyl acrylate (25 weight %) | | |
| (C-1) | 0.6 | g |
| Hexamethylene-1,6-bis(ethyleneurea) | 0.8 | g |
| Water to make | 1 | liter |

Subsequently, the surfaces of Subbing Layers A-1 and B-1 were subjected to corona discharging with 8 w/m²·minute. Onto the Subbing Layer A-1, the upper subbing layer coating composition a-2 described below was applied so as to form a dried layer thickness of 0.8 μm, which was designated Subbing Layer A-2, while onto the Subbing Layer B-1, the upper subbing layer coating composition b-2 was applied so at to form a dried layer thickness of 0.8 μm, having a static preventing function, which was designated Subbing Upper Layer B-2.

Upper subbing layer coating composition a-2

| | | |
|---|---|---|
| Gelatin in an amount (weight) to make | 0.4 | g/m² |
| (C-1) | 0.2 | g |
| (C-2) | 0.2 | g |
| (C-3) | 0.1 | g |
| Silica particles (av. size 3 μm) | 0.1 | g |
| Water to make | 1 | liter |

Upper subbing layer coating composition b-2

| | | |
|---|---|---|
| (C-4) | 60 | g |
| Latex solution (solid 20% comprising) | | |
| (C-5) as a substituent | 80 | g |
| Ammonium sulfate | 0.5 | g |
| (C-6) | 12 | g |
| Polyethylene glycol (average | 6 | g |
| molecular weight of 600) | | |
| Water to make | 1 | liter |

Additives used for preparation of a subbed support are as follows.

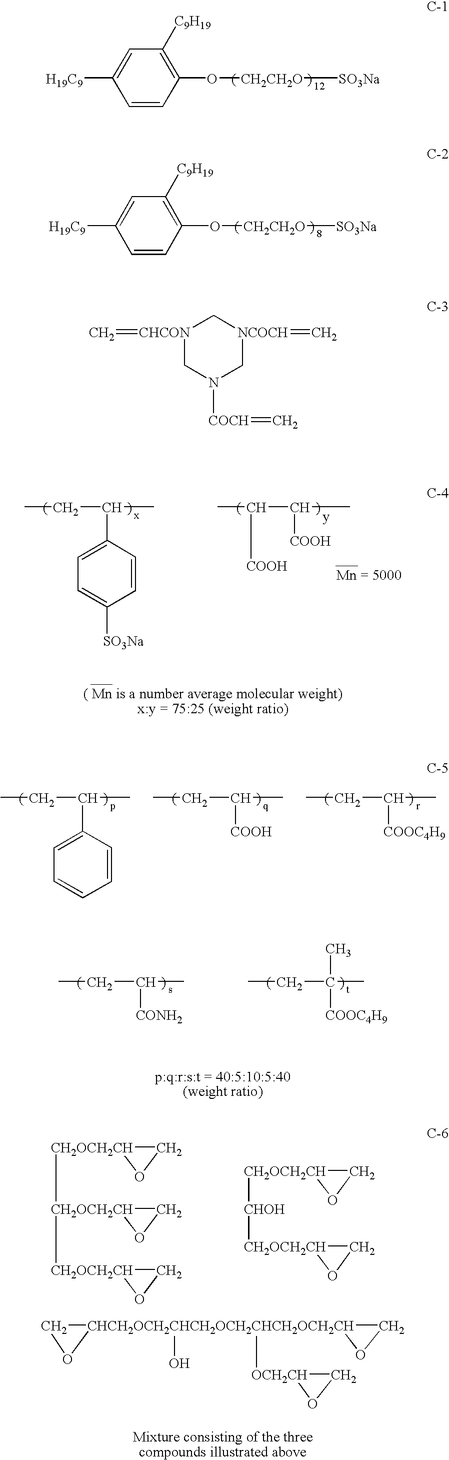

### Preparation of Backing Layer Coating Solution

To 830 g of methyl ethyl ketone (MEK), 84.2 g of cellulose acetate-butyrate (CAB381-20, available from Eastman Chemical Co.) and 4.5 g of polyester resin (Vitel PE2200B, available from Bostic Corp.) were added with stirring and dissolved therein. To the resulting solution was added 0.57 mmol of infrared dye 1, then, 4.5 g fluorinated surfactant (Surflon KH40, available from ASAHI Glass Co. Ltd.) and 2.3 g fluorinated surfactant (Megafag F120K, available from DAINIPPON INK Co. Ltd.) which were dissolved in 43.2 g methanol, were added thereto and stirred until being dissolved. Then, 75 g of silica (Siloid 64X6000, available from W.R. Grace Corp.), which was dispersed in methyl ethyl ketone in a concentration of 1 wt % using a dissolver type homogenizer, was further added thereto with stirring to obtain a coating solution for the backing layer.

The thus prepared coating solution of the backing layer was coated using an extrusion coater and dried so as to have a dry thickness of 3.5 μm. Drying was conducted over 5 min. using hot air at a drying temperature of 100° C. and a dew point of 10° C.

### Preparation of Light-Sensitive Silver Halide Emulsion A:

Solution A1

| Phenylcarbamoyl gelatin | 88.3 | g |
|---|---|---|
| Compound (A) (10% methanol solution) | 10 | ml |
| Potassium bromide | 0.32 | g |
| Water to make | 5429 | ml |
| Solution B1 | | |
| 0.67 mol/l Aqueous silver nitrate solution | 2635 | ml |
| Solution C1 | | |
| Potassium bromide | 51.55 | g |
| Potassium iodide | 1.47 | g |
| Water to make | 660 | ml |
| Solution D1 | | |
| Potassium bromide | 154.9 | g |
| Potassium iodide | 4.41 | g |
| Iridium chloride (1% solution) | 0.93 | ml |
| Water to make | 1982 | ml |
| Solution E1 | | |
| 0.4 mol/l aqueous potassium bromide solution | Amount | |
| | necessary | |
| | to adjust | |
| | silver potential | |
| Solution F1 | | |
| Potassium hydroxide | 0.71 | g |
| Water to make | 20 | ml |
| Solution G1 | | |
| Aqueous 56% acetic acid solution | 18 | ml |
| Solution H1 | | |
| Anhydrous sodium carbonate | 1.72 | g |
| Water to make | 151 | ml |
| Compound (A) | | |

| | |
|---|---|
| HO(CH₂CH₂O)ₙ—(CH(CH₃)CH₂O)₁₇—(CH₂CH₂O)ₘH | (m + n = |
| | 5 to 7) |

Using a stirring mixer described in JP-B 58-58288 and 58-58289, ¼ of solution B1, the total amount of solution C1 were added to solution A1 by the double jet addition for 4 min 45 sec. to form nucleus grain, while maintaining a temperature of 45° C. and a pAg of 8.09. After 1 min., the total amount of solution F1 was added thereto. After 6 min, ¾ of solution B1 and the total amount of solution D1 were further added by the double jet addition for 14 min 15 sec., while mainlining a temperature of 45° C. and a pAg of 8.09. After stirring for 5 min., the reaction mixture was lowered to 40° C. and solution G1 was added thereto to coagulate the resulting silver halide emulsion. Remaining 2000 ml of precipitates, the supernatant was removed and after adding 10 liters water with stirring, the silver halide emulsion was again coagulated. Remaining 1500 ml of precipitates, the supernatant was removed and after adding 10 liters water with stirring, the silver halide emulsion was again coagulated. Remaining 1500 ml of precipitates, the supernatant was removed and solution H1 was added. The temperature was raised to 60° C. and stirring continued for 120 min. Finally, the pH was adjusted to 5.8 and water was added there to so that the weight per mol of silver was 1161 g, and light-sensitive silver halide emulsion A was thus obtained.

It was proved that the resulting emulsion was comprised of monodisperse silver iodobromide cubic grains having an average grain size of 0.058 μm, a coefficient of variation of grain size of 12% and a [100] face ratio of 92%.

To the obtained emulsion was added 240 ml of sulfur sensitizer S-5 (0.5% methanol solution), and a gold sensitizer Au-5 was further added thereto in an amount equivalent to 1/20 mol of the sulfur sensitizer and stirred for 120 min. at 55° C. to perform chemical sensitization. Preparation of powdery organic silver salt A:

Behenic acid of 130.8 g, arachidic acid of 67.7 g, stearic acid of 43.6 g and palmitic acid of 2.3 g were dissolved in 4720 ml of water at 90° C. Then, 540.2 ml of aqueous 1.5 mol/L NaOH was added, and after further adding 6.9 ml of concentrated nitric acid, the mixture was cooled to 55° C. to obtain a fatty acid sodium salt solution. To the thus obtained fatty acid sodium salt solution, 45.3 g of light-sensitive silver halide emulsion B-3 obtained above and 450 ml of water were added and stirred for 5 min., while being maintained at 55° C. Subsequently, 702.6 ml of 1 mol/L aqueous silver nitrate solution was added in 2 min. and stirring continued further for 20 min., then, the reaction mixture was filtered to remove aqueous soluble salts. Thereafter, washing with deionized water and filtration were repeated until the filtrate reached a conductivity of 2 μS/cm. Using a flush jet dryer (produced by Seishin Kigyo Co., Ltd.), the thus obtained cake-like organic silver salt was dried under an atmosphere of inert gas (i.e., nitrogen gas) having a volume ratio shown in Table 1, according to the operation condition of a hot air temperature at the inlet of the dryer until reached a moisture content of 0.1%. The moisture content was measured by an infrared ray aquameter.

### Preparation of Pre-Dispersion A:

In 145/g MEK was dissolved 14.57 g of polyvinyl butyral powder (B-79, available from Monsanto Co.) and further thereto was gradually added 500 g of powdery organic silver salt A to obtain pre-dispersion A, while stirring by a dissolver type homogenizer (DISPERMAT Type CA-40, available from VMA-GETZMANN).

### Preparation of Light-Sensitive Emulsion 1:

Thereafter, using a pump, the thus prepared pre-dispersion A was transferred to a media type dispersion machine (DISPERMAT Type SL-C12 EX, available from VMA-GETZMANN), which was packed 1 mm Zirconia beads (TORESELAM, available from Toray Co. Ltd.) by 80%, and dispersed at a circumferential speed of 8 m/s and for 1.5 min. of a retention time with a mill to obtain light-sensitive emulsion 1.

### Preparation of Stabilizer Solution:

In 4.97 g of methanol were dissolved 1.0 g of Stabilizer 1 and 0.31 g of potassium acetate to obtain stabilizer solution.

### Preparation of Infrared Sensitizing Dye Solution A:

In 31.3 g of MEK were dissolved 1.7×10⁻⁵ mol of an infrared sensitizing dye (denoted as IR Dye 1 or 2, as shown in Table 1), 1.488 g of 2-chlorobenzoic acid, 2.779 g of Stabilizer 2 and 365 mg of 5-methyl-2-mercaptobenzimidazole in a dark room to obtain an infrared sensitizing dye solution A.

### Preparation of Additive Solution A:

Reducing agents shown in Table 1, 1.54 g of 4-methylphthalic acid and 0.92 mmol of infrared dye 1 were dissolved in 110 g of MEK to obtain additive solution a. Preparation of additive solution b:

In 40.9 g of MEK were dissolved 3.56 g of antifoggant 2 and 3.43 g of phthalazine to obtain additive solution b.

### Preparation of Light-Sensitive Layer Coating Solution:

Under inert gas atmosphere (97% nitrogen), 50 g of the light-sensitive emulsion 1 and 15.11 g MEK were maintained at 21° C. with stirring and 390 μl of antifoggant 1 (10% methanol solution) was added and stirred for 1 hr. Further thereto, 494 μl of calcium bromide (10% methanol solution) was added and stirred for 20 min. Subsequently, 167 ml of the stabilizer solution was added and after stirring for 10 min., 1.32 g of the infrared sensitizing dye solution was added and stirred for 1 hr. Then, the mixture was cooled to 13° C. and stirred for 30 min. Further thereto, 13.31 g of polyvinyl butyral (B-79) was added and stirred for 30 min, while maintaining the temperature at 13° C., and 1.084 g of tetrachlorophthalic acid (9.4 wt % MEK solution) and stirred for 15 min. Then, 12.43 g of additive solution a, 1.6 ml of 10% MEK solution of Desmodur N3300 (aliphatic isocyanate, product by Movey Co.) and 4.27 g of additive solution b were successively added with stirring to obtain coating solution of the light-sensitive layer.

### Preparation of Matting Agent Dispersion:

In 42.5 g methyl ethyl ketone was dissolved 7.5 g of cellulose acetate-butyrate (CAB171-15, available from Eastman Chemical Co.) and then 5 g of calcium carbonate (Super-Pflex 200, available from Speciality Mineral Corp.) was added thereto and dispersed using a dissolver type homogenizer at a speed of 800 rpm over a period of 30 min. to obtain calcium carbonate dispersion.

### Preparation of Coating Solution for Protective Layer:

To 865 g of methyl ethyl ketone were added with stirring 96 g of cellulose acetate-butyrate (CAB171-15, available from Eastman Chemical Co.) and 4.5 g of polymethyl methacrylate (Paraloid A-21, available from Rohm & Haas Corp.). Further thereto were added and dissolved 1.5 g of vinylsulfon compound HD-1, 1.0 g of benzotriazole and 1.0 g of fluorinated surfactant (Surflon KH40, available from ASAHI Glass Co. Ltd.). Finally, 30 g of the foregoing matting agent dispersion was added and stirred to obtain a coating composition for the surface protective layer.

### Coating of Light-Sensitive Layer Side:

The foregoing light-sensitive layer coating composition and protective layer coating composition were simultaneously coated by using an extrusion coater so that the silver coverage of the light-sensitive layer was 1.9 g/m² and dry thickness of the protective layer was 2.5 μm. Thereafter, drying was conducted using hot-air at a dry-bulb temperature of 75° C. and a dew point of 10° C. over a period of 10 min to obtain coated samples No. 1 to 32 of photothermographic material.

Additives used for preparation of photothermographic materials are as follows.

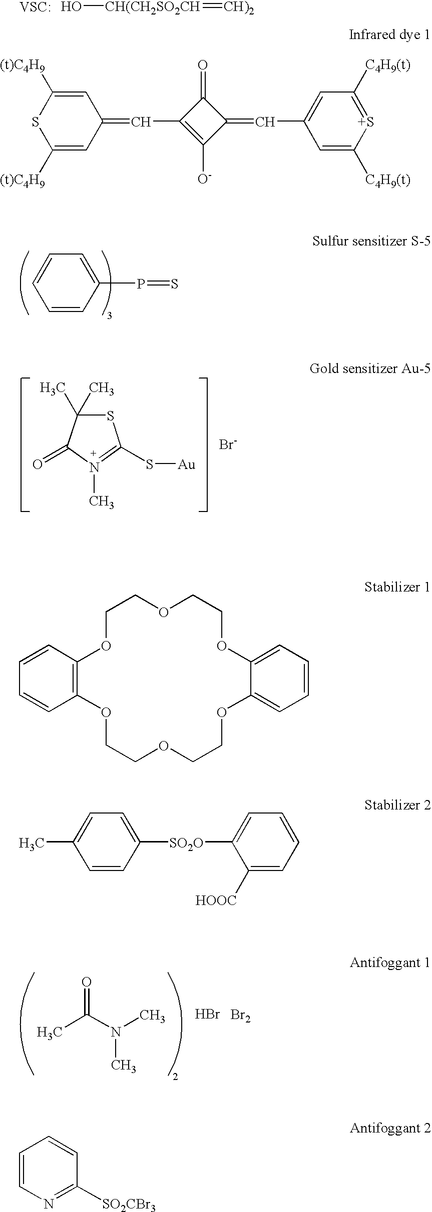

### Exposure and Processing:

Photothermographic material samples which were aged at 23° C. for 120 hr (denoted as aging condition A) and samples which were aged in an incubator at 50° C. and 55% RH for 120 hr. (denoted as aging condition B), were each subjected to laser scanning exposure from the protective layer side by an exposure machine using a semiconductor laser at a wavelength of 785 nm as a light source. Exposure was performed at an angle of 75 degrees between the exposed surface of photothermographic material and a laser beam. Such exposure resulted in formed images exhibiting minimized unevenness and surprisingly superior sharpness, compared to the case in which the angle was adjusted to 90 degrees.

Thereafter, while employing an automatic processor having a heating drum, the protective layer of each sample was brought into contact with the surface of the drum and thermal development was carried out at 123° C. over 15 sec. Exposure and thermal development were carried out in an atmosphere maintained at 23° C. and 50% RH. Then, the samples were evaluated as below.

Samples which were subjected to exposure and thermal development were evaluated based on the criteria as below. Evaluation results are shown in Table 1.

### Fogging:

The visual transmission density of an unexposed area was measured at 5 points using a densitometer (color transmission densitometer 310T, produced by X-Rite Co.) and the average value thereof was evaluated as the fog density (denoted as Fog)

### Maximum Density:

The visual transmission density of a maximum density area was measured at 3 points using a densitometer (color transmission densitometer 310T, produced by X-Rite Co.) and the average value thereof was evaluated as the maximum density (denoted as Dmax). Maximum densities of samples were represented by a relative value, based on the maximum density being 100 of sample No. 1 which was aged under aging condition A and processed in processing condition 1.

### Silver Image Storage Stability:

One of two sheets of a sample which was processed similarly to sensitometry, as described above, was aged at 25° C. and 55% RH for 7 days while being light-shielded, and the other one was aged at 25° C. and 55% RH for 7 days while being exposed to natural light. Densities of the fogged area of both aged samples were measured, and an increase of fog density (denoted as fog increase 1) was determined based on the following equation to evaluate storage stability of silver images (also denoted as image stability):

Fog increase 1=(fog density when aged while being exposed to natural light)−(fog density when aged while being light-shielded).

### Silver Image Color

A density area exhibiting a transmission density of 1.1±0.05 was visually observed and evaluated with respect to silver image color (tone), based on the following criteria:
5: it was neutral black tone and no yellowish tone was observed,
4: it was not neutral black but yellowish tone was scarcely observed,
3: a slightly yellowish tone was partially observed,
2: a slightly yellowish tone was overall observed,
1: a yellowish tone was apparently observed.

### In the foregoing, an evaluation of “4” or more represented no problem in quality assurance and was acceptable in practice.

TABLE 1

| | Reducing | Reducing | IR Dye 1 | IR Dye 2 | | | | | Silver |
|---|---|---|---|---|---|---|---|---|---|
| Sample | Agent | Agent | (x10⁻⁵ | (x10⁻⁵ | | | | Image | Image |
| No. | (mmol) | (mmol) | mol) | mol) | Aging | Fog | Dmax | Stability | Color |
| 1 (Comp.) | RED-1 (82.6) | — | 3-3 (2.7) | — | A | 0.27 | 100 | 0.20 | 1 |
| 2 (Comp.) | RED-2 (82.6) | — | 3-11 (2.7) | — | A | 0.17 | 70 | 0.15 | 3 |
| 3 (Comp.) | RED-3 (82.6) | — | 3-3 (2.7) | — | A | 0.18 | 80 | 0.05 | 2 |
| 4 (Comp.) | RED-1 (82.6) | — | 2-1 (1.35) | 2-2 (1.35) | A | 0.27 | 102 | 0.21 | 1 |
| 5 (Comp.) | RED-2 (82.6) | — | 2-4 (2.7) | — | A | 0.17 | 70 | 0.15 | 3 |
| 6 (Comp.) | RED-3 (82.6) | — | 2-6 (2.7) | — | A | 0.18 | 80 | 0.05 | 2 |
| 7 (Comp.) | RED-1 (82.6) | — | 3-1 (1.35) | 3-3 (1.35) | B | 0.40 | 95 | 0.20 | 1 |
| 8 (Comp.) | RED-2 (82.6) | — | 3-1 (1.08) | 3-3 (1.62) | B | 0.19 | 60 | 0.15 | 3 |
| 9 (Comp.) | D-1 (82.6) | — | 3-3 (1.35) | 3-12 (1.35) | A | 0.20 | 101 | 0.06 | 2 |
| 10 (Comp.) | RED-1 (57.8) | DEV-1 (24.8) | 2-4 (1.35) | 3-1 (1.35) | A | 0.25 | 96 | 0.19 | 1 |
| 11 (Inv.) | D-1 (82.6) | — | 2-4 (1.35) | 3-1 (1.35) | A | 0.16 | 111 | 0.02 | 5 |
| 12 (Inv.) | D-1 (82.6) | — | 2-4 (1.62) | 3-3 (1.08) | B | 0.17 | 110 | 0.02 | 5 |
| 13 (Inv.) | D-1 (82.6) | — | 2-4 (2.7) | — | B | 0.18 | 109 | 0.03 | 4 |
| 14 (Inv.) | D-1 (57.8) | DEV-1 (24.8) | 2-4 (1.35) | 3-1 (1.35) | A | 0.15 | 109 | 0.01 | 5 |
| 15 (Inv.) | D-1 (41.3) | DEV-1 (41.3) | 2-4 (1.35) | 3-1 (1.35) | A | 0.14 | 108 | 0.01 | 5 |
| 16 (Inv.) | D-3 (57.8) | — | 2-2 (2.7) | — | A | 0.16 | 100 | 0.03 | 4 |
| 17 (Inv.) | D-15 (57.8) | — | 2-3 (1.35) | 3-1 (1.35) | A | 0.16 | 103 | 0.03 | 5 |
| 18 (Inv.) | D-16 (57.8) | — | 2-21 (1.35) | 3-17 (1.35) | A | 0.17 | 104 | 0.03 | 4 |
| 19 (Inv.) | D-21 (82.6) | — | 2-4 (1.35) | 3-1 (1.35) | A | 0.15 | 115 | 0.03 | 5 |
| 20 (Inv.) | D-21 (82.6) | — | 2-4 (1.35) | 3-1 (1.35) | B | 0.16 | 113 | 0.03 | 5 |
| 21 (Inv.) | D-21 (66) | — | 2-4 (1.35) | 3-1 (1.35) | A | 0.14 | 113 | 0.01 | 5 |
| 22 (Inv.) | D-21 (57.8) | DEV-1 (24.8) | 2-4 (1.08) | 3-1 (1.62) | B | 0.16 | 108 | 0.03 | 5 |
| 23 (Inv.) | D-23 (82.6) | — | 2-16 (2.7) | — | A | 0.16 | 108 | 0.02 | 4 |
| 24 (Inv.) | D-23 (57.8) | — | 2-2 (1.62) | 3-6 (1.08) | B | 0.17 | 113 | 0.02 | 5 |
| 25 (Inv.) | D-48 (82.6) | — | 2-1 (1.35) | 3-1 (1.35) | A | 0.16 | 102 | 0.03 | 4 |
| 26 (Inv.) | D-51 (57.8) | — | 2-12 (2.7) | — | A | 0.15 | 105 | 0.02 | 4 |
| 27 (Inv.) | D-64 (82.6) | — | 2-21 (2.7) | — | A | 0.16 | 102 | 0.03 | 4 |
| 28 (Inv.) | D-88 (57.8) | — | 2-4 (2.7) | — | A | 0.16 | 107 | 0.02 | 4 |
| 29 (Inv.) | D-101 (82.6) | — | 2-4 (2.7) | — | A | 0.16 | 100 | 0.04 | 4 |
| 30 (Inv.) | D-101 (82.6) | — | 2-4 (1.35) | 3-1 (1.35) | A | 0.15 | 102 | 0.04 | 5 |
| 31 (Inv.) | D-101 (57.8) | DEV-1 (24.8) | 2-4 (1.35) | 3-1 (1.35) | A | 0.16 | 101 | 0.03 | 5 |
| 32 (Inv.) | D-101 (41.3) | DEV-1 (41.3) | 2-4 (1.35) | 3-1 (1.35) | A | 0.15 | 100 | 0.03 | 5 |

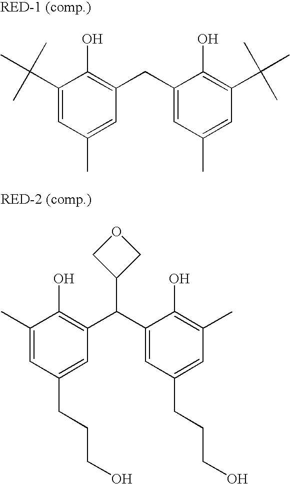

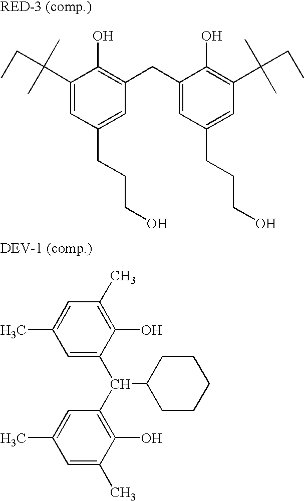

As can be seen from Table 1, it was proved that the use of reducing agents of the invention resulted in improved storage stability, reduced fogging and enhanced stability of silver images and superior silver image color.

What is claimed is:

1. A photothermographic material comprising on at least one side of a support a light-sensitive silver halide, wherein the photothermographic material further comprises a compound represented by formula (1) and a compound represented by formula (2): 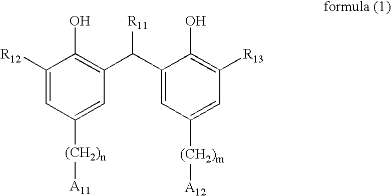
wherein R₁₁ is a hydrogen atom or a substituent; R₁₂ and R₁₃, are each a branched alkyl group or a cycloalkyl group; A₁₁ and A₁₂ are each a hydroxyl group or a group capable of forming a hydroxyl group upon deprotection; n and m are each an integer of 3 to 5, 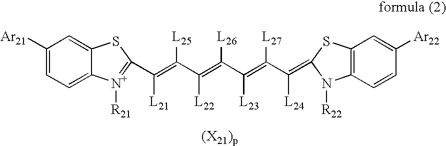
wherein L₂₁ through L₂₇ are each a hydrogen atom, a halogen atom, an amino group, an alkylthio group, an arylthio group, a lower alkyl group, a lower alkoxy group, an aryloxy group, an aryl group, a heterocyclic group or a nonmetallic atom group necessary to form a 5-, 6- or 7-membered ring by linking L₂₁ to L₂₂, L₂₂ to L₂₃, L₂₃ to L₂₄, L₂₅ to L₂6 or L₂₆ to L₂₇; R₂₁ and R₂₂ are each an aliphatic group, provided that R₂₁ and L₂₁ or R₂₂ and L₂₄ may combine with each other to form a 5-, 6- or 7-membered ring structure; Ar₂₁ and Ar₂₂ are each an aryl group or a heterocyclic group; X₂₁ is an ion necessary to compensate for an intramolecular charge and p is the number of ions necessary to compensate for an intramolecular charge.

2. The photothermographic material of claim 1, wherein the photothermographic material further comprises a compound represented by formula (3): 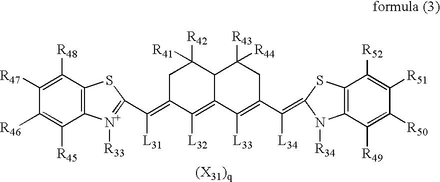
wherein L₃₁, through L₃₄ are each a hydrogen atom, a halogen atom, an amino group, an alkylthio group, an arylthio group, a lower alkyl group, a lower alkoxy group, an aryloxy group, an aryl group, a heterocyclic group or a nonmetallic atom group necessary to form a 5-, 6- or 7-membered ring by linking L₃₁ to L₃₂, L₃₂ to L₃₃ or L₃₃ to L₃₄; R₃₃ and R₃₄ are each an aliphatic group, provided that R₃₃ and L₃₁ or R₃₄ and L₃₄ may combine with each other to form a 5-, 6- or 7-membered ring structure; X₃₁ is an ion necessary to compensate for an intramolecular charge and q is the number of ions necessary to compensate for an intramolecular charge; R₄₁ to R₄₄ are each a hydrogen atom, an alkyl group or an aryl group; R₄₅ to R₅₂ are each a group capable of being substituted on a benzene ring, provided that R₄₅ and R_{46,} R₄₆ and R₇₁, R₄₇ and R_{48,} R₄₉ and R_{50,} R₅₀ and R₅₁ or R₅₁ and R₅₂ may combine with each other to form a ring structure, and R₄₇ is not an aryl group or a heterocyclic group.

3. The photothermographic material of claim 1, wherein in formula (1), A₁₁ and A₁₂ are each a hydroxyl group.

4. The photothermographic material of claim 1, wherein in formula (1), R₁₁ is a hydrogen atom.

5. The photothermographic material of claim 1, wherein in formula (1), R₁₁ is an alkyl group.

6. The photothermographic material of claim 1, wherein in formula (1), R₁₂ and R₁₃ are each a tertiary alkyl group.

7. The photothermographic material of claim 1, wherein in formula (1), n and m are each 3.

8. The photothermographic material of claim 1, wherein in formula (2), Ar₂₁ and Ar₂₂ are each an aryl group.

9. The photothermographic material of claim 1, wherein in formula (2), R₂₁ and R₂₂ are each an alkyl group having 4 to 16 carbon atoms.

10. The photothermographic material of claim 1, wherein in formula (2), Ar₂₁ and Ar₂₂ are each a phenyl group.

11. The photothermographic material of claim 1, wherein the photothermographic material comprises a light-insensitive organic silver salt.
